(19) United States
(12) Patent Application Publication
(10) Pub. No.: US 2004/0006499 A1
(43) Pub. Date: Jan. 8, 2004

(54) System and method for providing information to a customer via a network

(76) Inventors: Vasileios Vergopoulos, Woodstock, MD (US); Jeffrey A. Wilhide, Finksburg, MD (US); Philomena M. Strawley, Ellicott City, MD (US); Gary M. Stokes, Fallston, MD (US); Henry L. Jackson II, Pikesville, MD (US); Shaun S. Poulton, Sykesville, MD (US); Anthony J. Guidi, Bel Air, MD (US); Parag M. Shah, Hughesville, MD (US); Denis Khazan, Owings Mills, MD (US); John P. Roberts III, Reisterstown, MD (US)

Correspondence Address: Finnegan, Henderson, Farabow,, Garrett & Dunner, L.L.P., 1300 I Street, N.W., Washington, DC, 20005-3315, US

(21) Appl. No.: 10/186,686

(22) Filed: Jul. 2, 2002

(51) Int. Cl. G06F 17/60

(52) U.S. Cl. 705/7

(57) ABSTRACT

Systems and methods provide information to a customer via a network. In one embodiment, the information may include test results that are stored in a database, and customers may access the test results via a website. Accordingly, a customer may submit a sample of a substance to an analysis service provider for testing. After conducting tests on the substance sample, the analysis service provider may post the test results on the website. In one embodiment, the test results may pertain, for example, to the analysis of substances related to petrochemical products, such as catalysts, with refineries as the customers. The way in which information is presented to a customer may be customized according to customer preferences. To protect sensitive data, security procedures may include identification of the customer based on his location in the network, such as an IP address of a computer. Customized reports may be generated based on customer-specific needs or industry standards. Analysis for several customers or across an entire industry may be part of the information provided to a customer. In one embodiment, a user may emulate other users for purposes such as viewing information on a website.

### DESCRIPTION OF THE INVENTION

I. Field of the Invention

The present invention relates to systems and methods for providing information to customers via a network. In particular, the present invention relates to systems and methods for providing information related to the analysis of substances corresponding to a customer in a customized way via a network.

II. Background of the Invention

Many businesses today use and rely upon various substances. These businesses often have the substances analyzed for a variety of reasons. For example, a business may be able to improve efficiency or reduce costs based on the analysis of a substance. Within the petrochemical refining industry, petroleum refineries use catalysts as part of the refining process. By having a catalyst analyzed after it is used, a refinery may determine whether any part of the refining process may be improved. In the medical industry, doctors and hospitals frequently need to have substances, such as blood samples, analyzed for a variety of reasons, such as diagnosis and treatment. In the automotive industry, automobile repair shops need substances, such as gasoline and oil, analyzed. Indeed, any entity that uses any type of substances may benefit from the analysis of the substances.

Substance analysis and related services may be provided by an analysis service provider that receives a sample of a substance from a customer, analyzes the substance, and returns results of the analysis to the customer. For example, a laboratory may receive a blood sample from a doctor's office, perform one or more tests on the blood sample, and return a report to the doctor's office with results of the one or more tests. In another example, a chemical company may receive a sample of a used catalyst from a petroleum refinery, perform one or more tests on the sample, and return the test results to the refinery.

In traditional systems, days or weeks may elapse before the test results are returned to the customer. Delay by an analysis service provider may be due to a number of factors. If multiple tests are performed, an analysis service provider may hold the test results until all of the tests have been completed, delaying the results of tests completed earlier. Many analysis service providers manually create reports to communicate the test results, resulting in delays if the analysis service provider becomes too busy. Furthermore, returning test results using traditional channels, such as the mail, can further delay the receipt of results. Delays of days or even hours may prevent a customer from making optimum use of the test results. It is therefore desirable to provide substance analysis results to customers as quickly as possible.

To make the best use of substance analysis data, customers may wish to have the data reported in a customized fashion. For example, a customer may wish to have recent test results listed together with historical test results to determine any trends. Additionally, a customer may wish to receive all test results via an electronic medium, such as facsimile or e-mail, or in a specific format, such as a spreadsheet or pie chart. It is desirable therefore to provide test results that can be customized according to a customer's preferences.

One obstacle to making substance analysis data readily available to customers is the highly sensitive nature of this type of data. For example, medical data is subject to strict confidentiality requirements to protect patients. Corporate data may include trade secrets or other valuable business-related information. While customers desire quick test results, they are unwilling to compromise the security of their data. It is therefore necessary to ensure data security in any system designed to provide substance analysis information to customers.

Another difficulty in making substance analysis data available to customers is the size and complexity of some customers. For example, multiple employees of a single corporation may require access to the same data. In some cases, different employees may need to access different portions of the data or may have different preferences for viewing the data. For example, a supervisor may need to access data available to his subordinates for management purposes. In another example, a trainer or salesperson may need to access data available to a user in order to train the user. Therefore, a system for providing substance analysis data to a customer should allow for multiple users to access data according to different preferences and needs.

In reporting substance analysis data, the analysis service provider must protect its proprietary information as well as that of its customers. For example, proprietary calculations may be used by the analysis service provider when analyzing substances. When the test results are presented to a customer, these proprietary calculations must be protected.

In addition to the analysis of its own substances, a customer may benefit from viewing substance analysis data for several customers or an entire industry. For example, a refinery may benefit from knowing how its used catalysts compare with catalysts used by a competing refinery. While this information may be highly beneficial, a customer might be reluctant to submit to such analysis in order to prevent divulging sensitive information to its competitors. Therefore, it is desirable to develop a system for providing industry analysis to customers while protecting any sensitive information.

In view of these obstacles as well as other considerations, there is a need for a system for presenting information such as substance analysis data and services to customers in an efficient and robust manner.

### SUMMARY OF THE INVENTION

Systems and methods consistent with the present invention allow customers to access information over a network, such as the Internet, that may be accessed and presented in various ways based on customer choices.

In one embodiment of the present invention, the information may be related to the analysis of substances corresponding to a customer. For example, test results may be stored in a database and customers may access the test results via a website. In this embodiment, a customer takes a sample of a substance and submits the sample to an analysis service provider for testing. The analysis service provider conducts tests on the substance sample and posts the test results on a website. The way in which test results are presented to the customer may be customized according to customer preferences. The test results may pertain, for example, to the analysis of substances related to petrochemical products, such as catalysts, with refineries as the customers. However, consistent with the present invention, the test results may pertain to the testing of any substance.

Consistent with another embodiment of the present invention, security may be provided to protect customer information and customize the presentation of information on a website. For example, a “user identification” feature may be used to recognize each specific user based on a security recognition procedure. The security recognition procedure may include verification of a user name, password, digital certificate, and security certificate mapped to a particular computer based on the computer's Internet protocol (IP) address. Once a user is recognized, the user's preferences may be automatically selected and used when presenting information to the user, e.g., on a website.

In another embodiment of the present invention, a user may emulate other users for purposes such as viewing information on a website. In this embodiment, when a user accesses the website, the user may be identified as the user himself, or the user may be identified as another user. Security procedures may define when a user is able to emulate another user. For example, a manager may be able to emulate his or her subordinates. In another example, a salesperson or trainer may access the website with the user, in order to teach the user how to access the website.

Another embodiment of the present invention generates reports, such as reports based on test results. The reports may be generated in part using proprietary calculations. In this case, although a customer may view test results and may view the results of calculations based on the test results, the customer may not necessarily have access to the proprietary calculations. Reports may be generated based on specific customer needs or industry standards. For example, a conversion utility may automatically convert a web-based report into a spreadsheet file containing graphs specified by a customer. The spreadsheet file may be formatted according to stored information to ensure compatibility with the customer's software and may be available for the customer to download. Test results for a customer may be maintained for an unlimited period of time, so that historical analyses and reports may be provided to the customer.

Still another embodiment of the present invention provides customers with industry analysis. For example, when customers submit samples for testing, the test results may be stored in a database. In addition to analysis of individual customers' test results, all of the test results may be analyzed to produce an industry-wide analysis, such as an industry average or industry mean. Customers may then compare their own test results to those of others in a given industry or to industry-wide results. The industry analysis information may be presented to customers in a way that does not disclose the origin of the data to protect the confidentiality of individual customers.

Additional advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 is a block diagram of a system consistent with an embodiment of the present invention;

FIG. 2 is a block diagram of another system consistent with an embodiment of the present invention;

FIG. 3 is a block diagram of a customer in greater detail consistent with an embodiment of the present invention;

FIG. 4 is block diagram of an analysis service provider consistent with an embodiment of the present invention;

FIG. 5 is a block diagram of a customer interface in greater detail consistent with an embodiment of the present invention;

FIG. 5.1 is a sample home page for a website consistent with an embodiment of the present invention;

FIG. 5.2 is a sample registration page for a website consistent with an embodiment of the present invention;

FIG. 6 is a block diagram of membership information in greater detail consistent with an embodiment of the present invention;

FIG. 6.1 is a sample registered user home page for a website consistent with an embodiment of the present invention;

FIG. 7 is a block diagram of a technical library consistent with an embodiment of the present invention;

FIG. 7.1 is a sample technical publications page for a website consistent with an embodiment of the present invention;

FIG. 7.2 is a sample useful contacts page for a website consistent with an embodiment of the present invention;

FIG. 8 is a block diagram of troubleshooting in greater detail consistent with an embodiment of the present invention;

FIG. 8.1 is a sample troubleshooting page for a website consistent with an embodiment of the present invention;

FIG. 9 is a block diagram of product ordering in greater detail consistent with an embodiment of the present invention;

FIG. 9.1 is a sample product information page for a website consistent with an embodiment of the present invention;

FIG. 9.2 is a sample online order form for a website consistent with an embodiment of the present invention;

FIG. 9.3 is a sample order history page for a website consistent with an embodiment of the present invention;

FIG. 9.4 is a sample delivery history report for a website consistent with an embodiment of the present invention;

FIG. 10 is a sample emulation screen consistent with an embodiment of the present invention;

FIG. 11 is a block diagram of file exchange consistent with an embodiment of the present invention;

FIG. 12 is a block diagram of a database in greater detail consistent with an embodiment of the present invention;

FIG. 13 is a block diagram of a security module in greater detail consistent with an embodiment of the present invention;

FIG. 14 is a block diagram of user authentication information in greater detail consistent with an embodiment of the present invention;

FIG. 15 is a block diagram of general public access information in greater detail consistent with an embodiment of the present invention;

FIG. 16 is a block diagram of an analysis module in greater detail consistent with the present invention;

FIG. 17 is a block diagram of analysis tools in greater detail consistent with an embodiment of the present invention;

FIG. 18 is a block-diagram of industry analysis in greater detail consistent with an embodiment of the present invention;

FIG. 19 is a block diagram of customer-specific analysis in greater detail consistent with an embodiment of the present invention;

FIG. 20 is a block diagram of a reporting module in greater detail consistent with an embodiment of the present invention;

FIG. 21 is a block diagram of a report generator in greater detail consistent with an embodiment of the present invention;

FIG. 22 is a block diagram of an interface for viewing reports in greater detail consistent with an embodiment of the present invention;

FIG. 23 is a block diagram of user reports in greater detail consistent with an embodiment of the present invention;

FIG. 24 is a block diagram of report formats in greater detail consistent with an embodiment of the present invention;

FIG. 25.1 is a sample technical information page for a website consistent with an embodiment of the present invention;

FIG. 25.2 is a sample customer-specific analysis page for a website consistent with an embodiment of the present invention;

FIG. 25.3 is a sample customer-specific report for a website consistent with an embodiment of the present invention;

FIG. 25.4 is a sample test detail report for a website consistent with an embodiment of the present invention;

FIG. 25.5 is a sample fresh substance analysis page for a website consistent with an embodiment of the present invention;

FIG. 25.6 is a sample fresh substance test detail report for a website consistent with an embodiment of the present invention;

FIG. 25.7 is a sample industry analysis page for a website consistent with an embodiment of the present invention;

FIG. 25.8 is a sample industry report for a website consistent with an embodiment of the present invention;

FIG. 25.9 is a sample comparison detail report for a website consistent with an embodiment of the present invention;

FIG. 25.10 is a sample advanced substance analysis report for a website consistent with an embodiment of the present invention; and

FIG. 25.11 is a sample advanced substance analysis by catalyst report for a website consistent with an embodiment of the present invention.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

I. System Overview

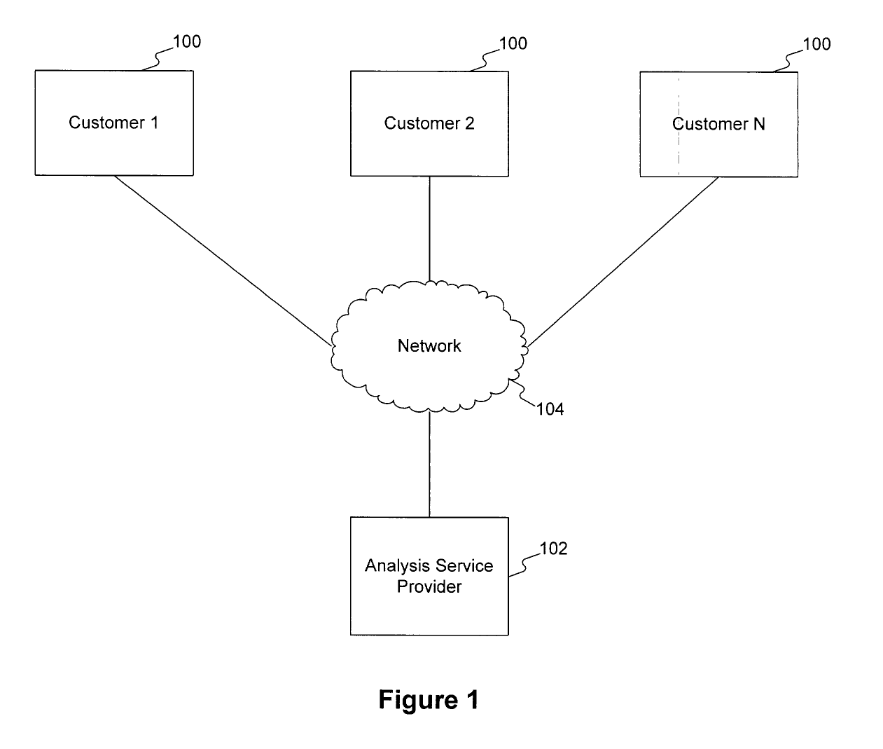

FIG. 1 is a block diagram of a system consistent with an embodiment of the present invention. A plurality of customers 100 communicate with an analysis service provider 102 via a network 104. Customers 100 may be, for example, refineries of petrochemical products or any other entities that need substance analysis and/or related services. Analysis service provider 102 may be, for example, a provider and analyzer of catalysts and additives for use in petrochemical refining. Consistent with the present invention, analysis service provider 102 may also be any other entity that provides substance analysis and/or related services. Network 104 may be, for example, the Internet or any other collection of two or more nodes or computers.

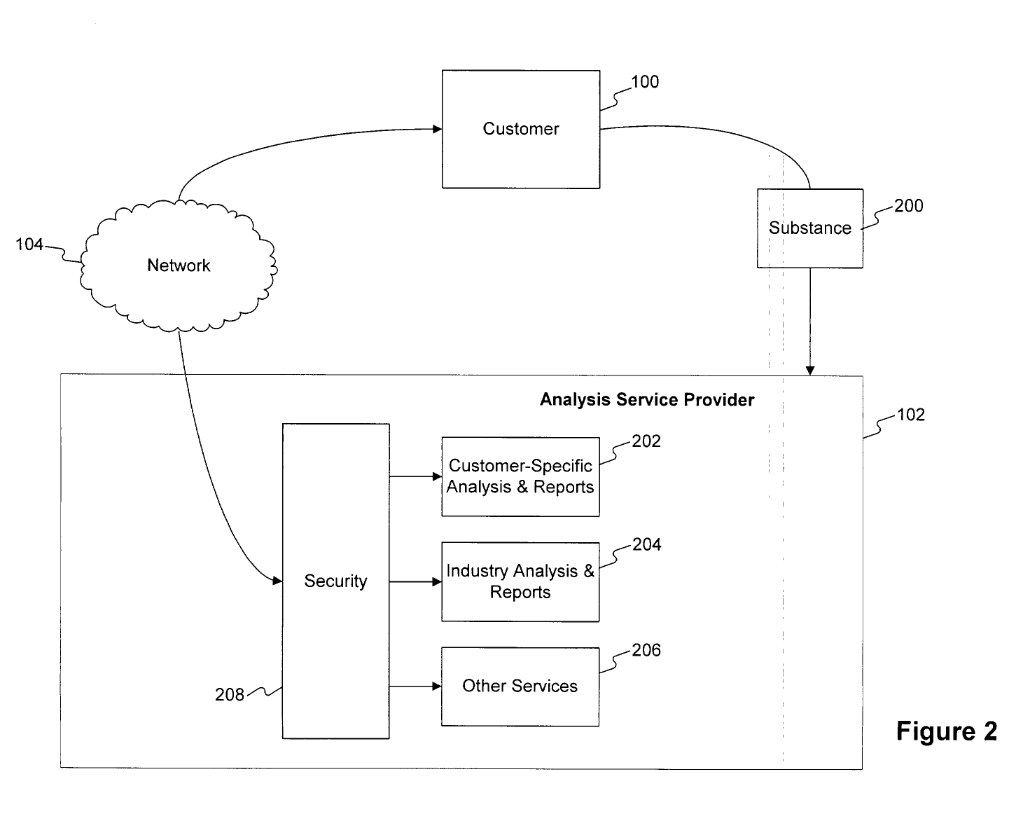

FIG. 2 is a block diagram of another system consistent with an embodiment of the present invention. As shown, a customer 100 sends a substance 200 to analysis service provider 102. The substance may be sent to analysis service provider 102 either directly or indirectly. Substance 200 may be, for example, a petrochemical product or other substance for testing, e.g., physical or chemical testing. Analysis service provider 102 analyzes substance 200 and, based on results of the analysis, produces customer-specific analysis and reports 202, industry analysis and reports 204, and other services 206. To access this information, customer 100 communicates with analysis service provider 102 via network 104. For example, customer 100 may use a web browser to access a website stored on a web server at analysis service provider 102. Customer 100 may be subjected to security procedures 208 before being able to access customer-specific analysis and reports 202, industry analysis and reports 204, and/or other services 206.

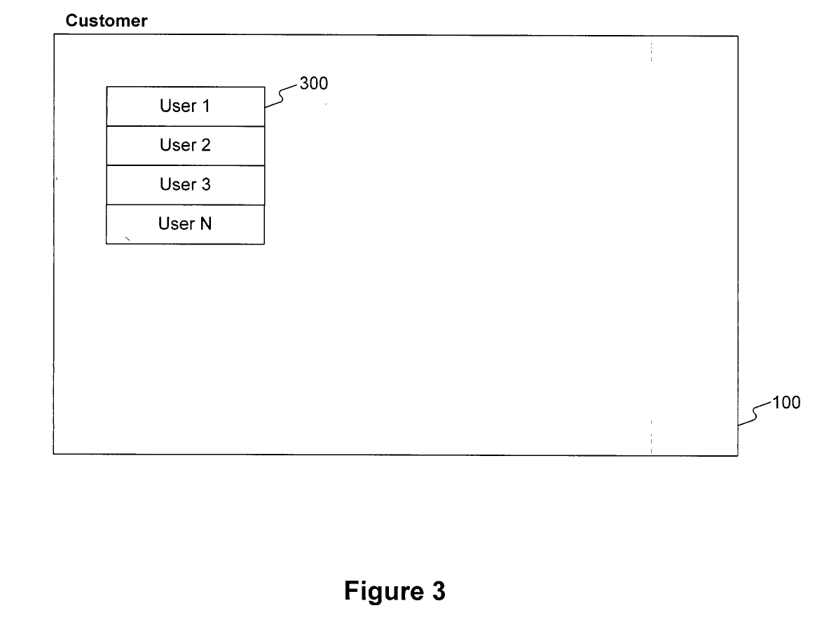

FIG. 3 is a block diagram of a customer in greater detail, consistent with an embodiment of the present invention. Customer 100 may have any number of corresponding users 300. For example, customer 100 may be a corporation with many individuals needing access to analysis service provider 102. In this embodiment of the present invention, each individual may be characterized as a user corresponding to the customer, i.e., the corporation. For example, customer may be a petrochemical refinery, User 1 may be an engineer at the refinery, User 2 may be a purchasing officer at the refinery, and User 3 may be the purchasing officer's manager. Consistent with the present invention, a user may be characterized as a group of individuals, such as a department sharing a single computer or a business unit of a corporation. One skilled in the art will appreciate that customer 100 may include any number of users 300.

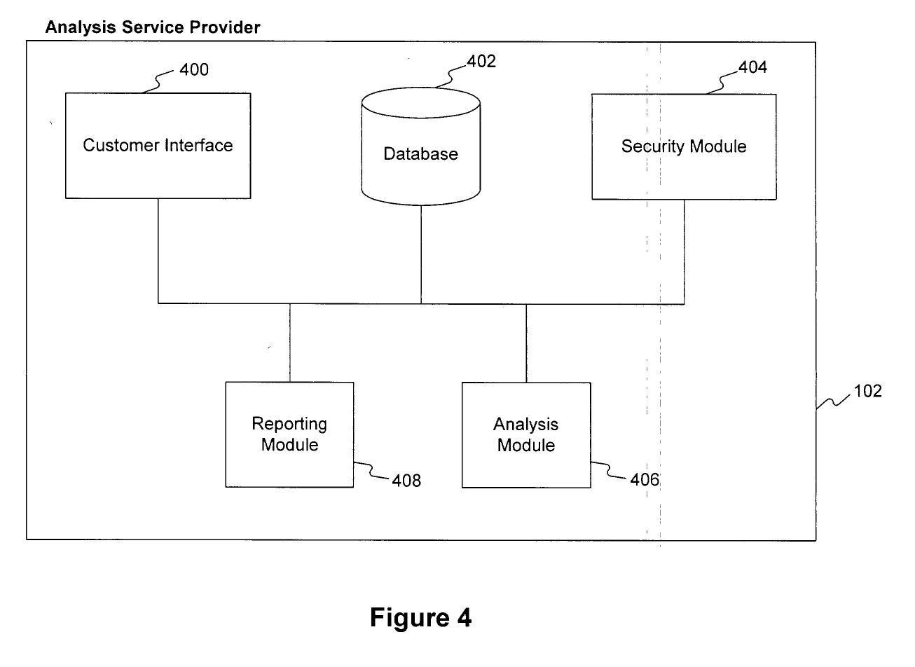

FIG. 4 is block diagram of an analysis service provider, consistent with an embodiment of the present invention. Analysis service provider 102 may be, for example, a provider and analyzer of catalysts and additives for use in petrochemical refining. Analysis service provider 102 may include, for example, a customer interface 400, a database 402, a security module 404, an analysis module 406, and a reporting module 408.

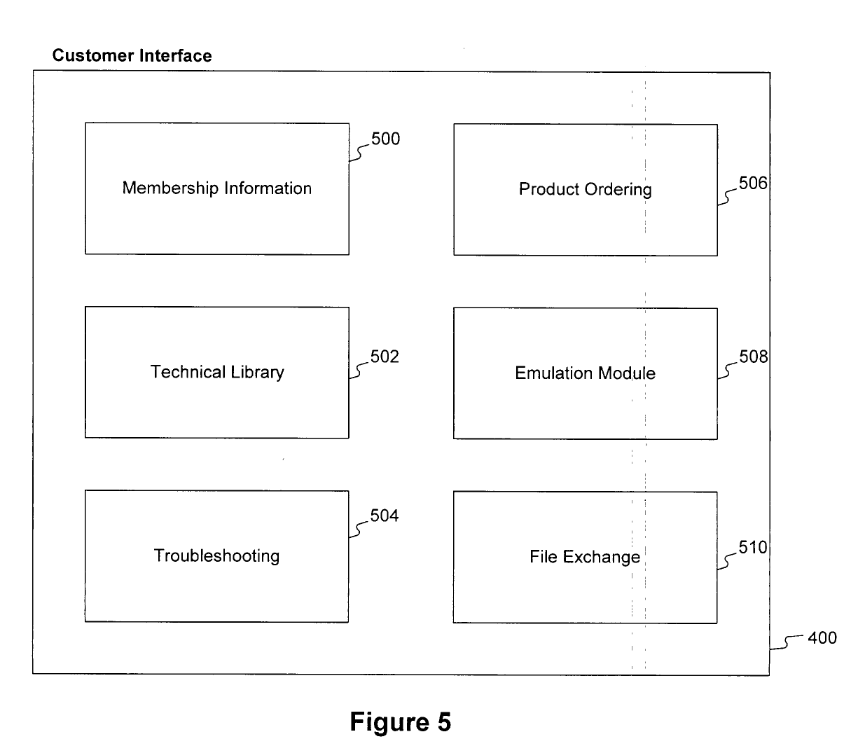

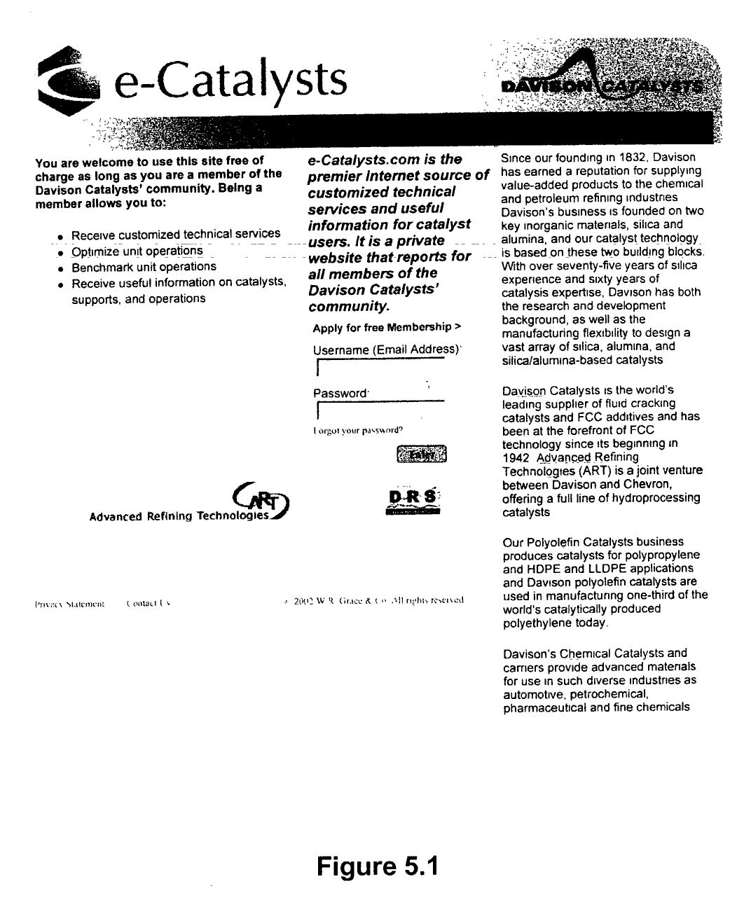

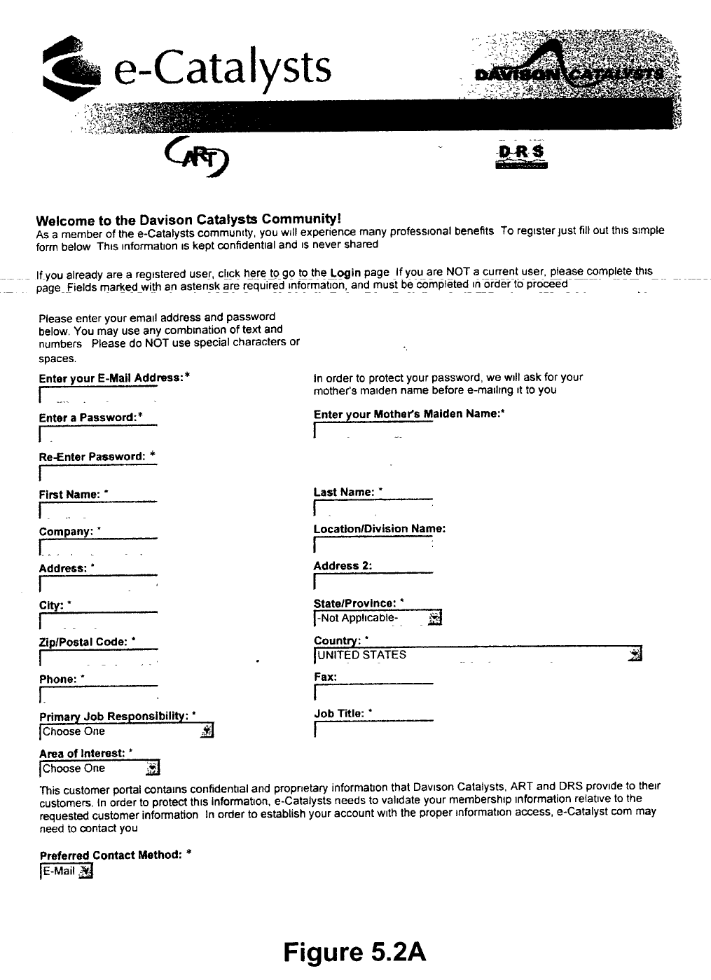

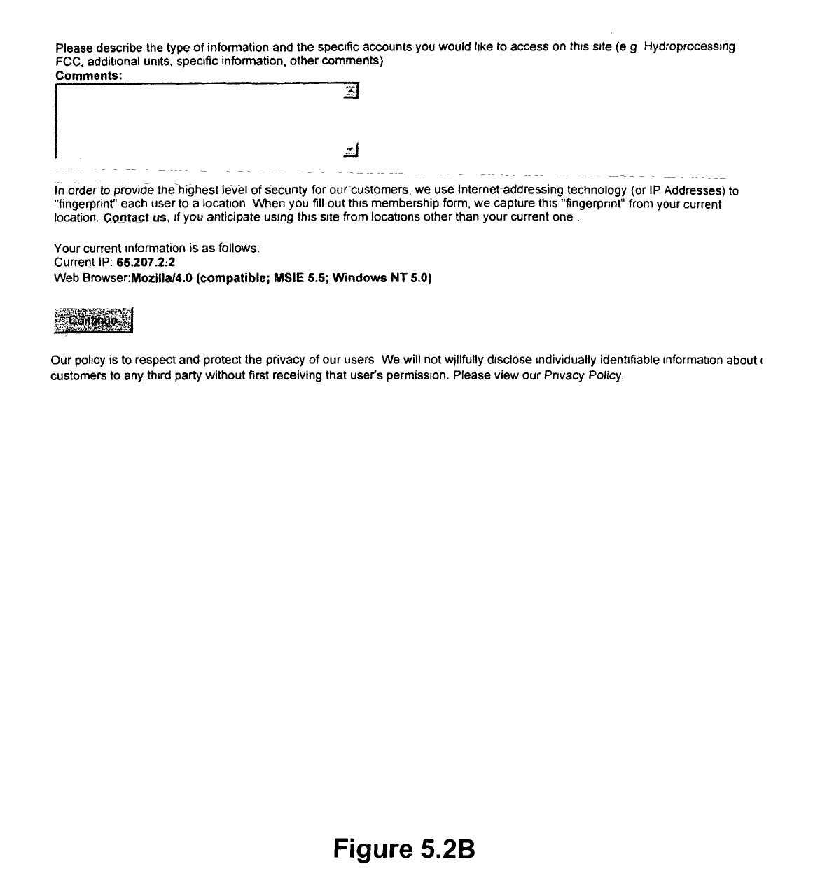

Customer interface 400 may enable communication between customers 100 (not shown) and analysis service provider 102 via network 104 (not shown). For example, customer interface 400 may include a web server for providing a website accessible by the Internet. Customer interface 400 is described in greater detail below with reference to FIGS. 5-11.

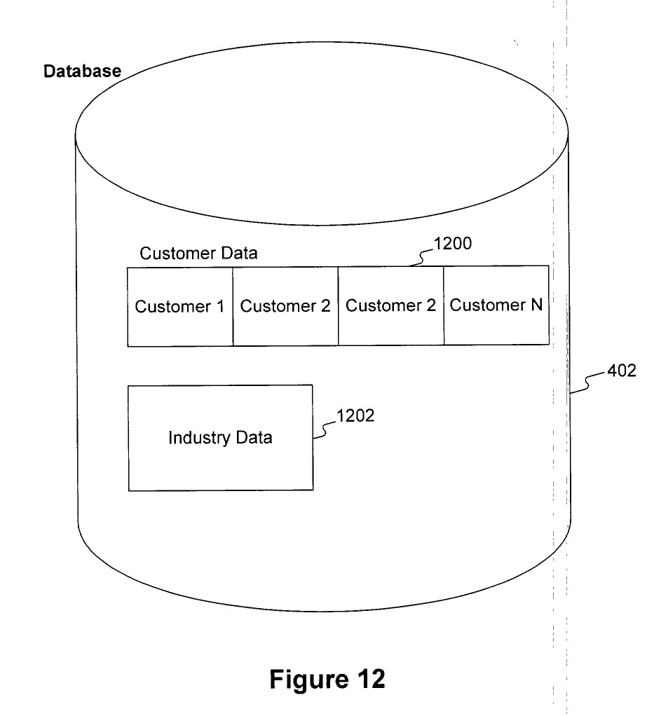

Database 402 may provide data storage for analysis service provider 402. Data stored in database 402 may be used by customer interface 400, security module 404, analysis module 406, and reporting module 408. Database 402 is described in greater detail below with reference to FIG. 12.

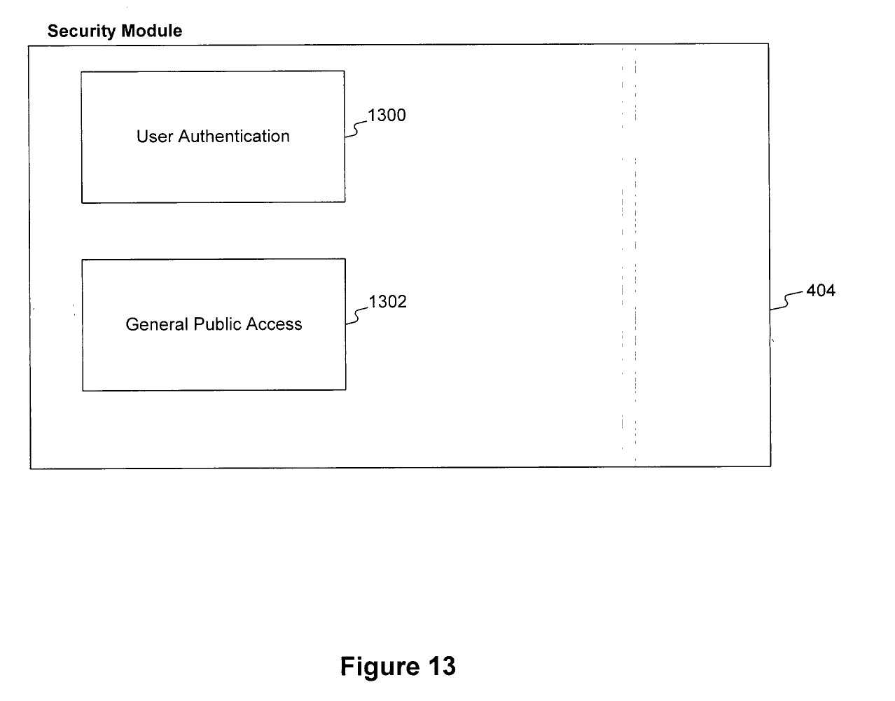

Security module 404 may be used to provide security for analysis service provider 102. For example, security module 404 may recognize and verify customers 100 that attempt to communicate with analysis service provider 102. Security module 404 is described in greater detail below with reference to FIGS. 13-15.

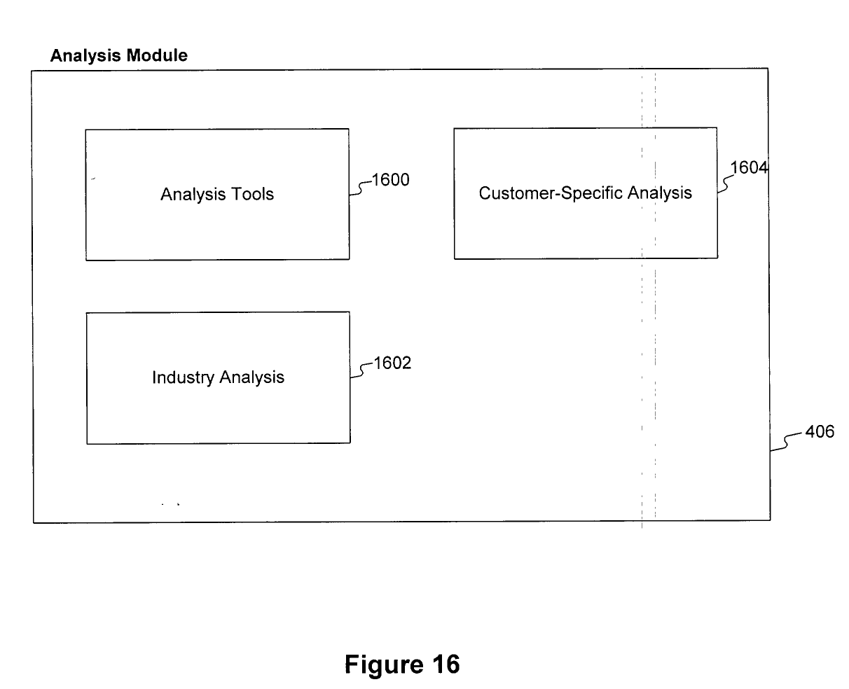

Analysis module 406 may be used, for example, to analyze substances received from customers. Analysis module 406 is described in greater detail below with reference to FIGS. 16-19.

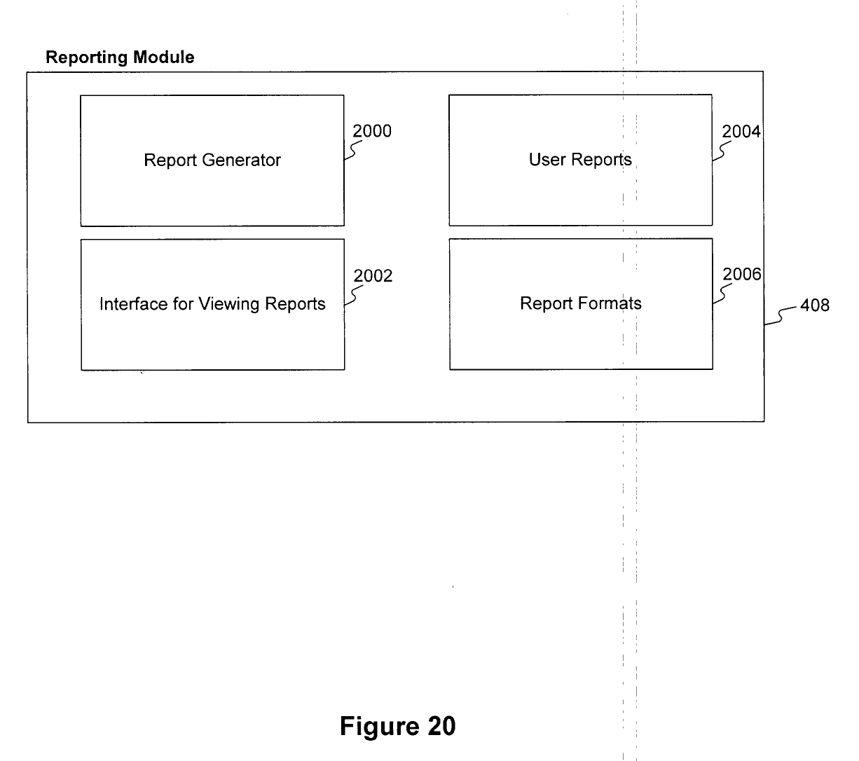

Reporting module 408 may be used to prepare and present reports for customers 100. Reporting module 408 is described in greater detail below with reference to FIGS. 20-24.

II. Customer Interface

FIG. 5 is a block diagram of a customer interface in greater detail, consistent with an embodiment of the present invention. Customer interface 400 may include membership information 500, a technical library 502, troubleshooting 504, product ordering 506, an emulation module 508, and file exchange 510. In an embodiment of the present invention, customer interface 400 may include a web server (not shown) for providing an analysis service provider website accessible by the Internet. The website may provide customers with access to membership information 500, technical library 502, troubleshooting 504, product ordering 506, emulation module 508, and file exchange 510.

FIG. 5.1 is a sample home page for a website consistent with an embodiment of the present invention. The home page may be presented, for example, to any member of the general public using the Internet address for the analysis service provider's website. The home page may include, for example, a list of member services, a log-in section, and information about the analysis service provider. The home page may be updated and presented via customer interface

FIG. 5.2 is a sample registration page for a website consistent with an embodiment of the present invention. The registration page may be presented, for example, when an individual chooses a link on the home page to apply for membership. The member registration page may request, for example, a user's e-mail address, password, name, company (or customer) name, address, and a password protector, such as mother's maiden name.

The registration page may also request a user's location or division name within the company, a job title, a primary job responsibility, and an area of interest. The primary job responsibility field may be presented to the user as a dropdown list, with options such as analytical services, corporate engineering, operations, planning, purchasing, research and development, and training. The area of interest field may also be presented to the user as a drop-down list including options such as refining catalysts, chemical catalysts, polyolefin catalysts, or general information. The membership registration page may also allow the user to indicate a preferred contact method, such as e-mail, phone, fax, or mail, as well as providing a space for comments from the user, such as the type of information or accounts that the user would like to access using the analysis service provider's website. Customer interface 400 may collect the registration information and store it in, for example, membership information 500.

Security may also be implemented as part of the registration process. For example, when the registration page is completed by a user, customer interface may use Internet addressing technology to capture the user's “fingerprint,” i.e., the current location of the computer used by the user. The fingerprint information may be displayed to the user as part of the registration page so that the user may verify the location from which he plans to access the analysis service provider's website in the future. After collecting the fingerprint information, customer interface 400 may store it together with the user's registration information in membership information 500.

A. Membership Information

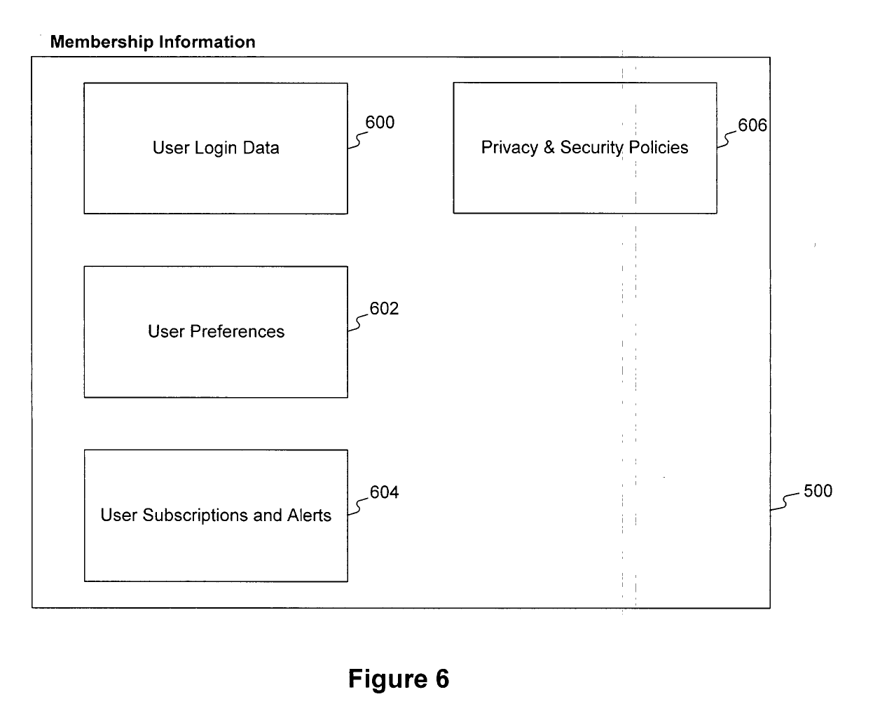

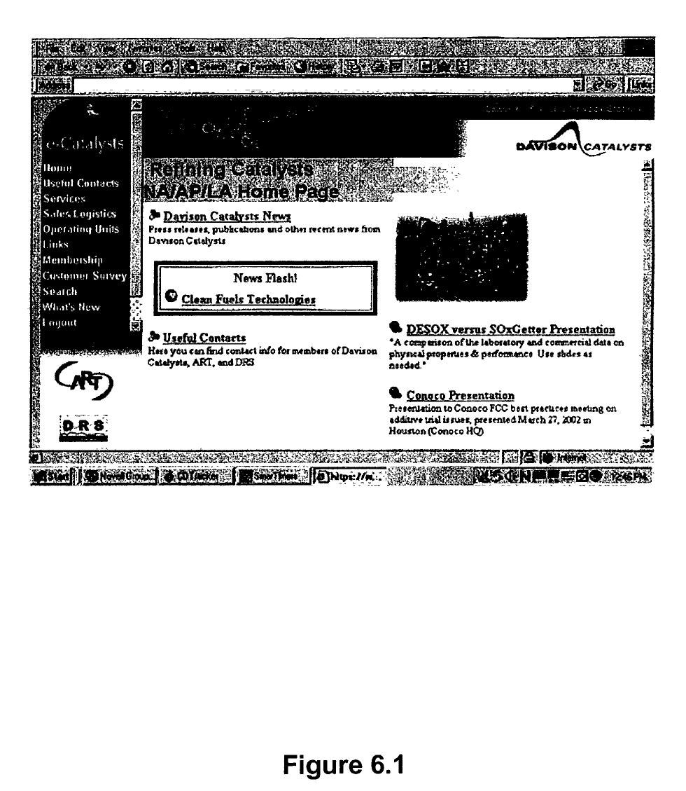

FIG. 6 is a block diagram of membership information in greater detail, consistent with an embodiment of the present invention. Membership information 500 may include user login data 600, user preferences 602, user subscriptions and alerts 604, and privacy and security policies 606. User login data 600 may include, for example, the information collected during the registration process described above. User preferences 602 may include, for example, customized home page information or access information for a user. User subscriptions and alerts 604 may include user-specific requests for subscriptions and/or alerts. For example, the user may be wish to be alerted whenever results of an analysis are available or whenever a new product becomes available. These types of requests would be stored in user subscriptions and alerts 604. Privacy and security policies 606 may include, for example, policies of the analysis service provider and/or the analysis service provider's website. Membership information 500 may be stored, for example, in database 402 and made available to customers via customer interface 400.

FIG. 6.1 is a sample registered user home page for a website consistent with an embodiment of the present invention. Once a user registers as a user of the analysis service provider's website, a new home page may be presented. In one embodiment, on the public home page (as shown in FIG. 5.1), a registered user may be given the option to enter a user name, such as an e-mail address, and a password and to click a button to log on to the site as a registered user. The registered user home page may then be displayed. The registered user home page may include, for example, links to news, useful contacts, and other pertinent information.

Using the registered user home page, a registered user may easily navigate among the services offered by the analysis service provider's website. A menu may list the various information available to registered users via customer interface 400. This information may include, for example, technical references, contact information, troubleshooting, and product ordering.

B. Technical Library

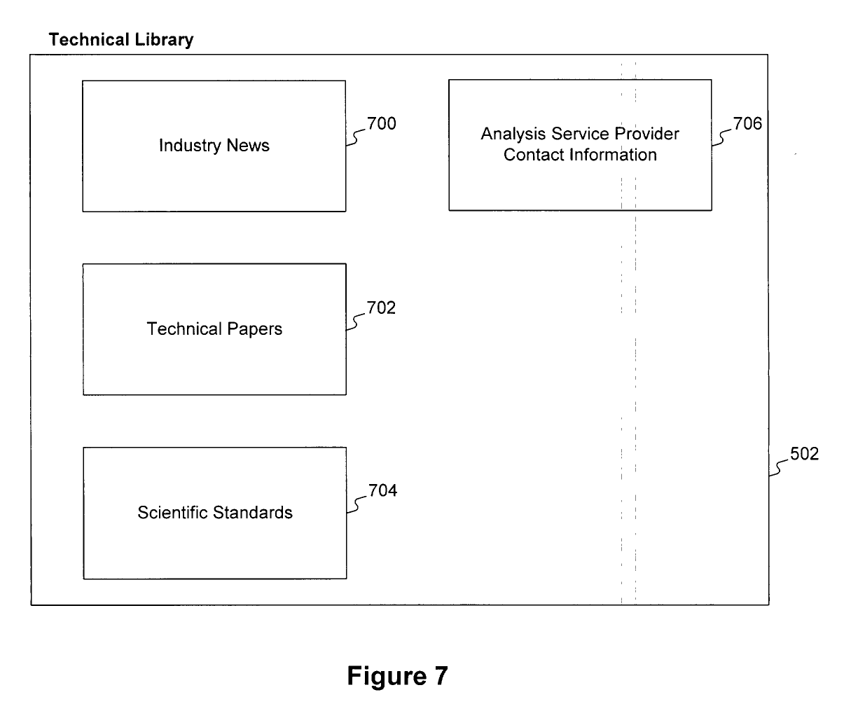

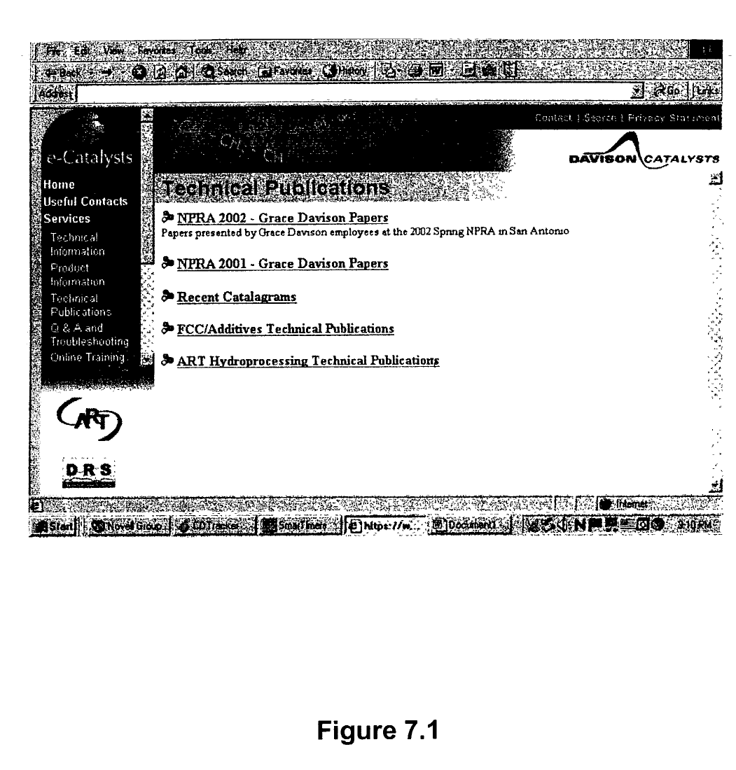

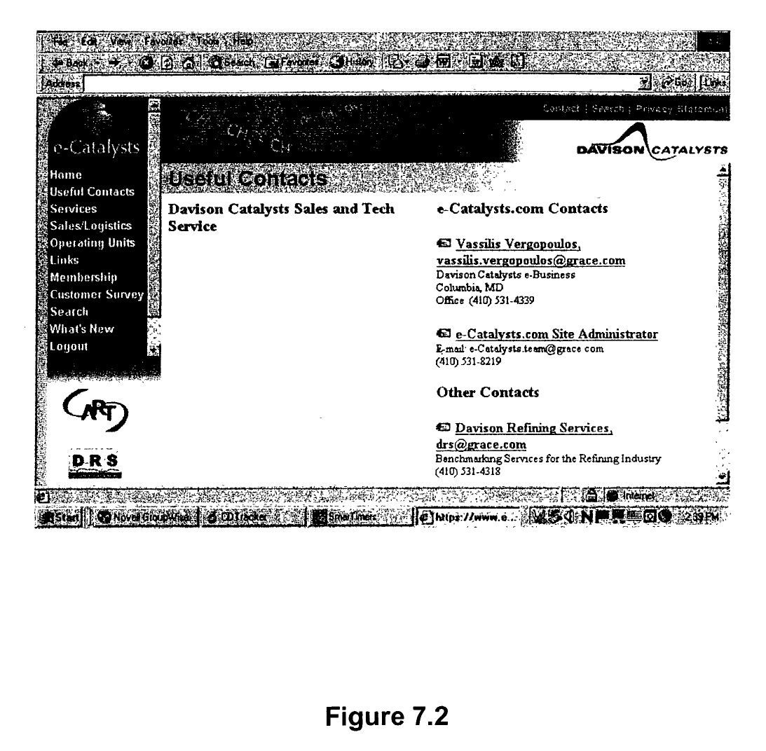

FIG. 7 is a block diagram of a technical library consistent with an embodiment of the present invention. Technical library 502 may include, for example, industry news 700, technical papers 702, scientific standards 704, and analysis service provider contact information 706. The information in technical library 502 may be stored in database 402 and made available to customers via customer interface 400.

FIG. 7.1 is a sample technical publications page for a website consistent with an embodiment of the present invention. Technical publications in technical library 502 may include, for example, technical papers and publications created by the analysis service provider or others in the industry. Other information in technical library 502 may include technical papers presented by analysis service provider employees, industry technical publications, and other publications.

FIG. 7.2 is a sample useful contacts page for a website consistent with an embodiment of the present invention. The useful contacts page may include, for example, analysis service provider contact information 706. Useful contacts may include, for example, contact information for various individuals or departments at the analysis service provider. The useful contacts page may include, for example, a contact person's name, e-mail address, department, address, and phone number. These contact listings may appear as links to the registered user. By choosing a contact person, for example, by clicking the contact person's name link, an e-mail may automatically open addressed to the contact person from the registered user.

C. Troubleshooting

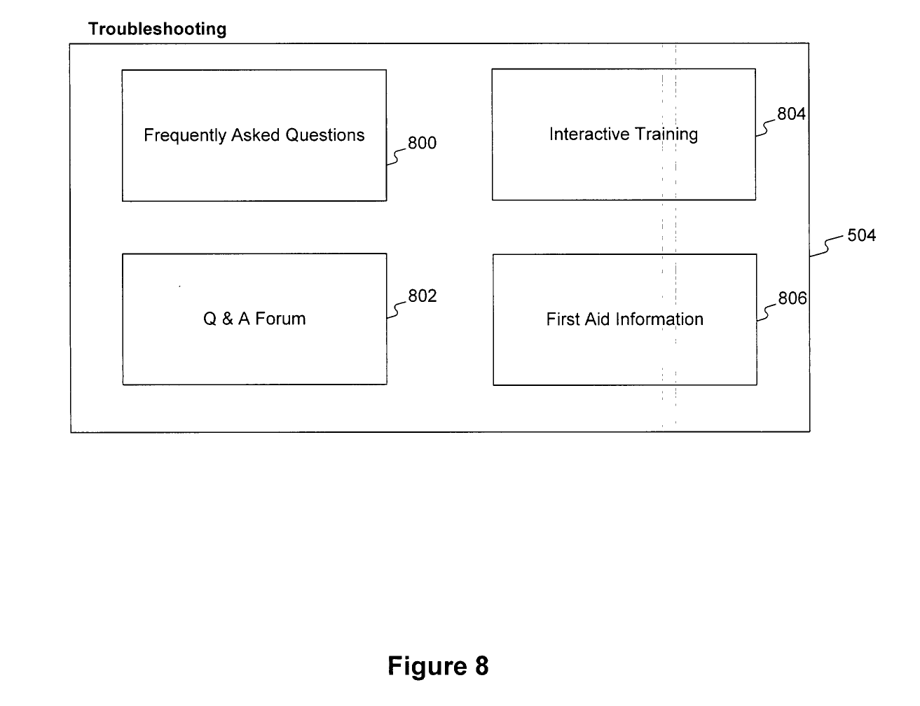

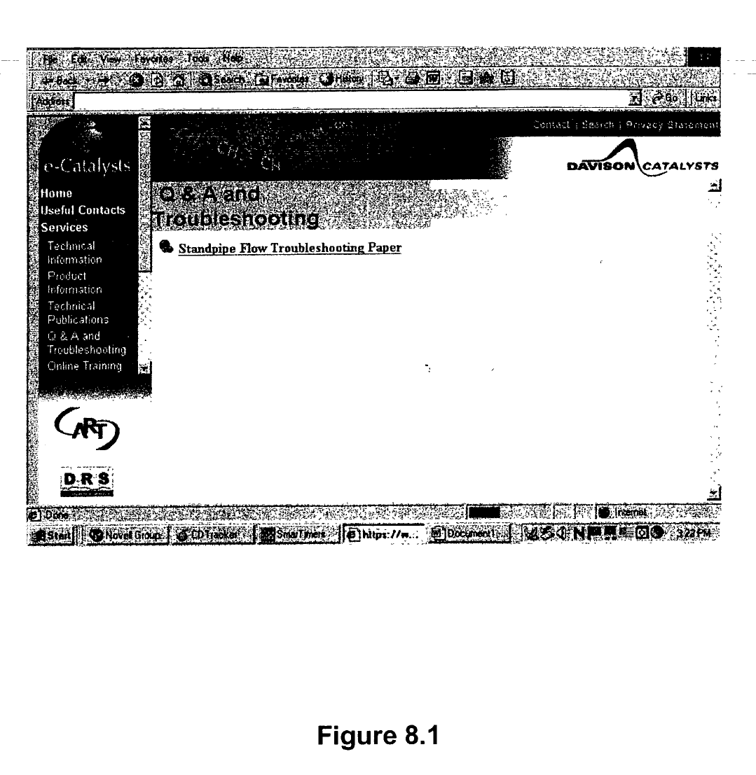

FIG. 8 is a block diagram of troubleshooting in greater detail consistent with an embodiment of the present invention. Troubleshooting 504 may include, for example, frequently asked questions 800, a Q&A forum 802, interactive training 804, and first aid information 806. Troubleshooting information 504 may be stored, for example, in database 402 and made available to the customer via customer interface 400.

FIG. 8.1 is a sample troubleshooting page for a website consistent with an embodiment of the present invention. The troubleshooting page may include any of the information available in troubleshooting 504, such as papers written by the analysis service provider or other parties for troubleshooting by customers.

D. Product Ordering

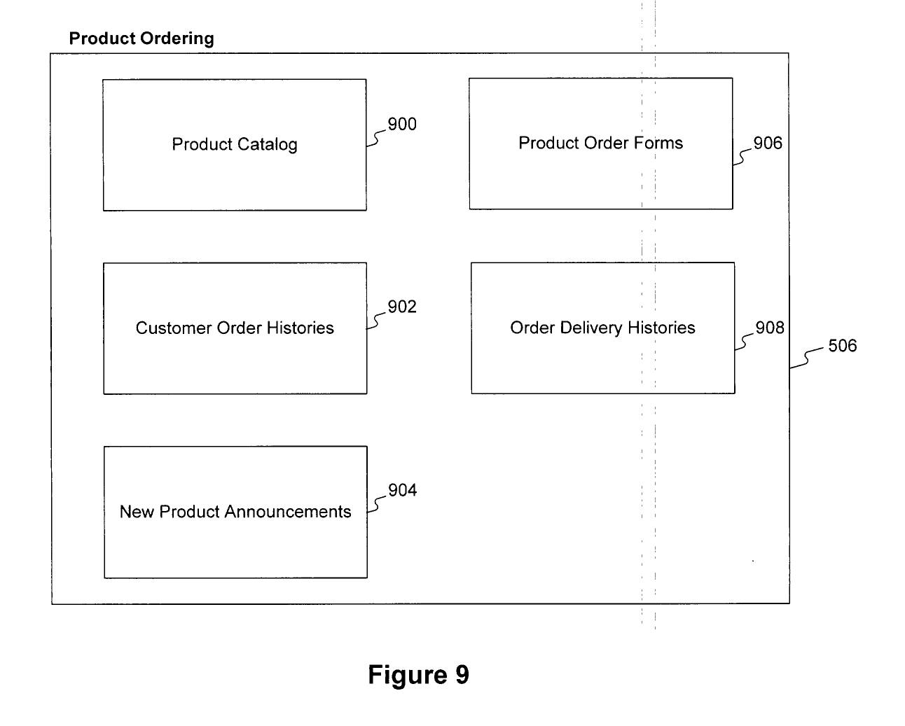

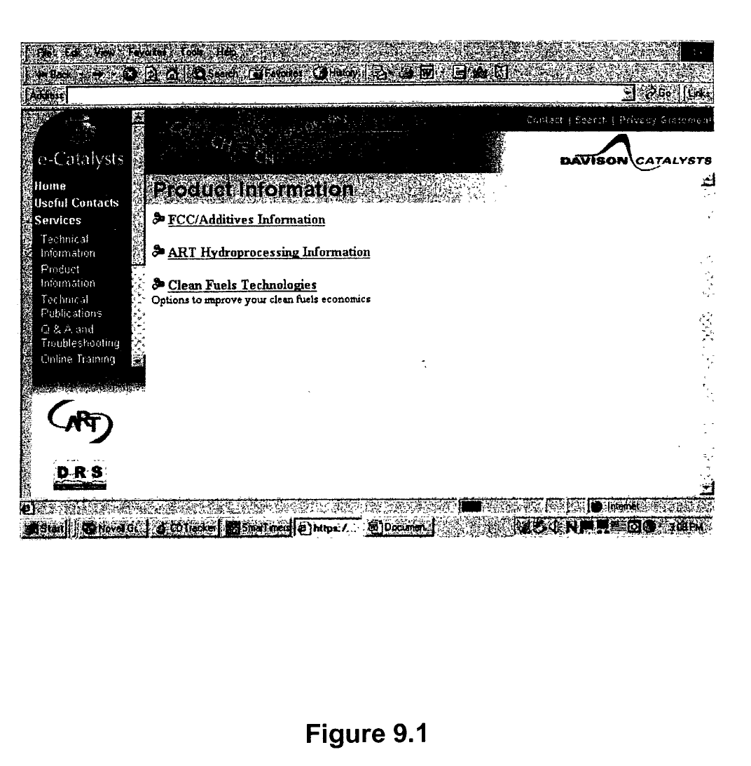

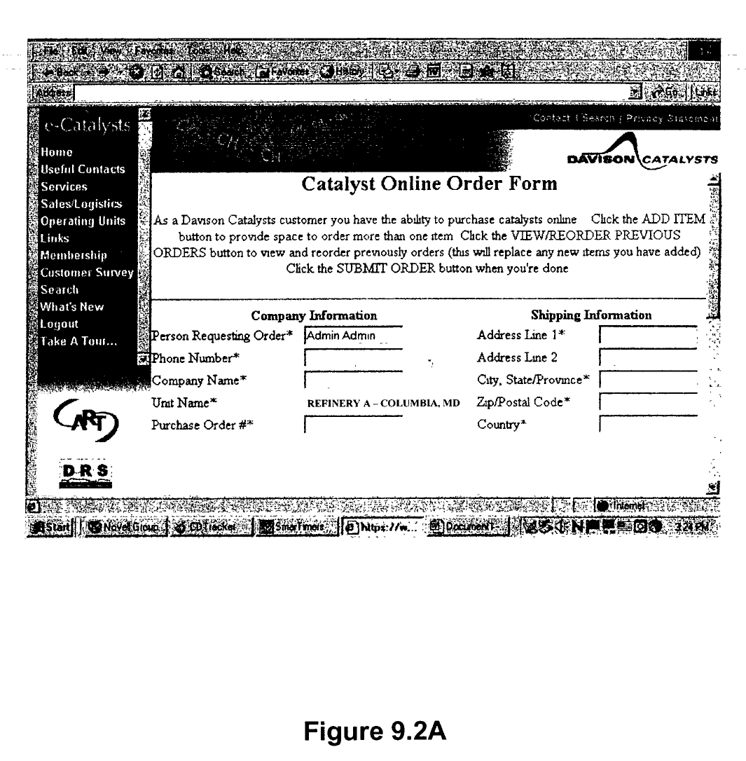

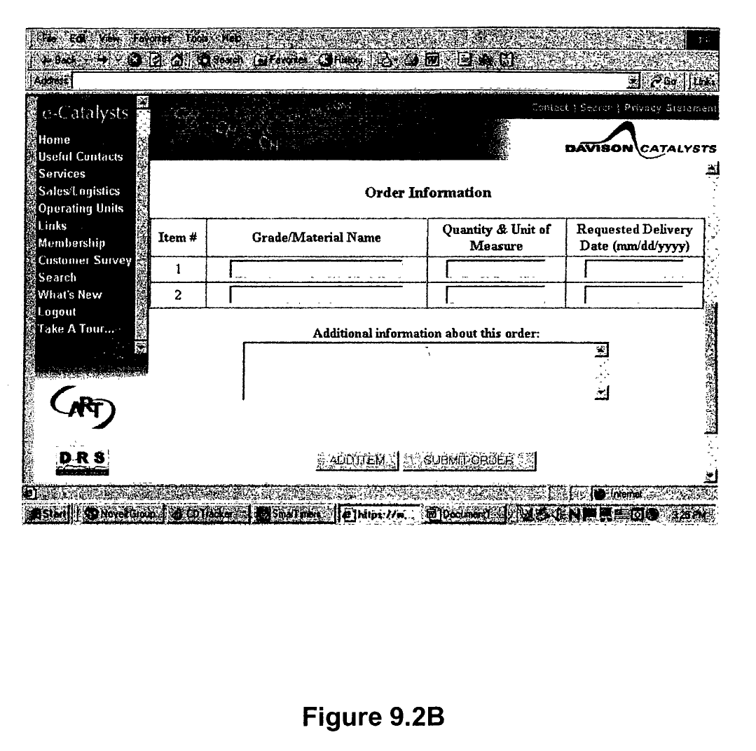

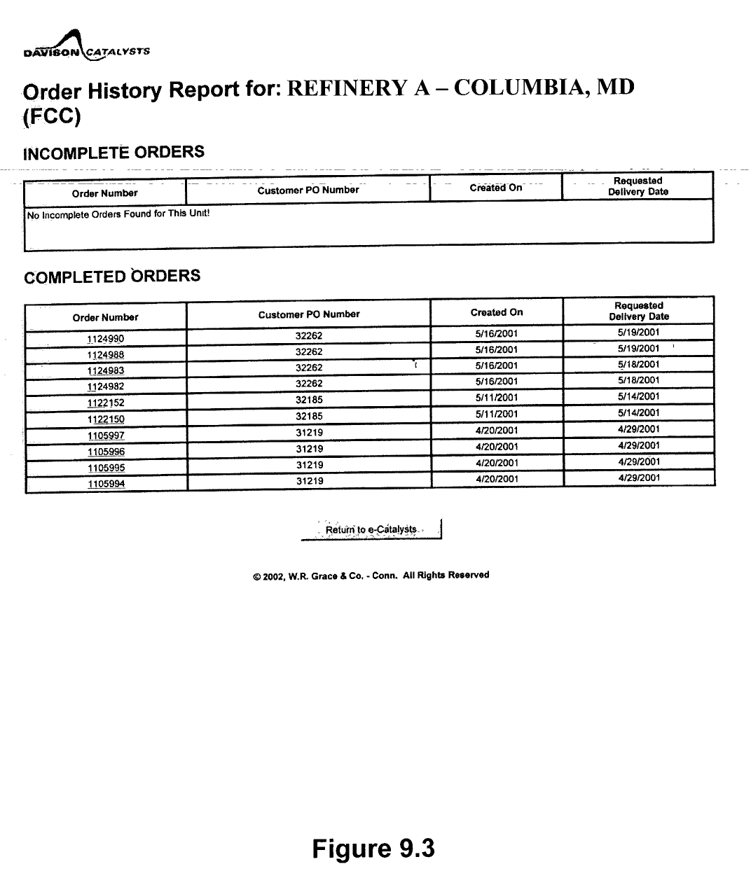

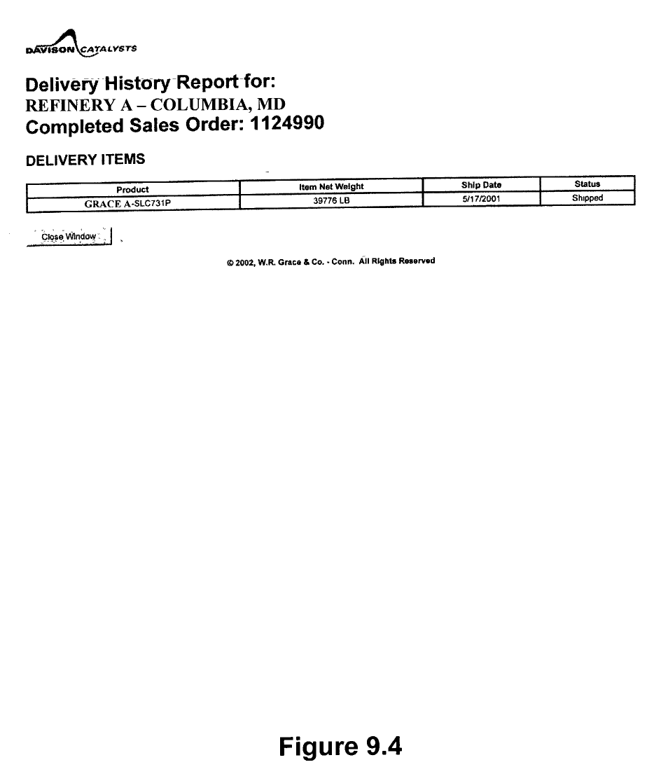

FIG. 9 is a block diagram of product ordering 506 in greater detail consistent with an embodiment of the present invention. Product ordering 506 may include, for example, a product catalog 900, customer order histories 902, new product announcements 904, and product order forms 906. Using product ordering 506, a user may browse products available for purchase, review products that the user has purchased in the past, keep abreast of the newest product announcements, and place orders electronically using product order forms.

FIG. 9.1 is a sample product information page for a website consistent with an embodiment of the present invention. The product information page may include, for example, information pertaining to product catalog 900.

FIG. 9.2 is a sample online order form for a website consistent with an embodiment of the present invention. The online order form may be stored in product order forms 906 and made available via customer interface 400 to enable a user to place an order for catalysts or other substances. The online order form may include, for example, the person requesting the order, a phone number, the company or customer name, the unit name, the purchase order number, and shipping information. The online order form may also include a list of items to be ordered including an item number, grade or material name, quantity and unit of measure, and requested delivery date. The online order form may also include a window in which the user can enter additional information about this order. Using the online user form, the user may have the option to view previous orders or to reorder items previously purchased, for example by accessing customer order histories 902.

FIG. 9.3 is a sample order history page for a website consistent with an embodiment of the present invention. The order history page may be displayed if a user requests to see an order history for a customer. The order history page may include, for example, incomplete orders and completed orders. For each order listed on the order history report, an order number, a customer PO number, date created, and requested delivery date may be displayed.

FIG. 9.4 is a sample delivery history report for a website consistent with an embodiment of the present invention. Each order number on an order history page may be a link to additional information about the order. For example, clicking on the purchase order number may display the delivery history report for a specific order. The delivery history report may include, for example, the product name, item net weight, ship date, and status. Data for the delivery history report may be included, for example, in order delivery histories 908.

E. Emulation Mode

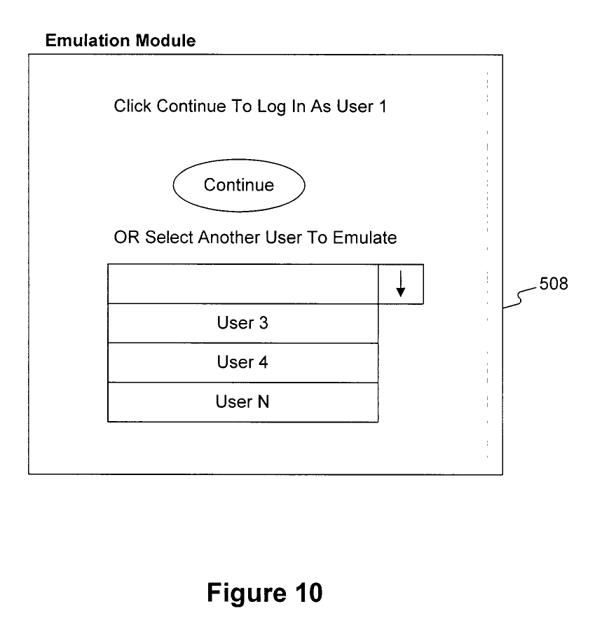

FIG. 10 is a sample screen for using an emulation process consistent with an embodiment of the present invention. Emulation module 508 enables a user to log on to analysis service provider 102 as another user. As shown in FIG. 10, the user may choose to continue to log-in as himself, e.g., User 1, or may select from a list of other possible users to emulate. The other users may be listed, for example, in a drop-down list. The emulation rules may be part of the user's membership information 502. For example, a supervisor may be permitted to emulate his employees in order to conduct business with analysis service provider 102. Also, a sales representative may be permitted to emulate any customer or any user with analysis server provider 102.

F. File Exchange

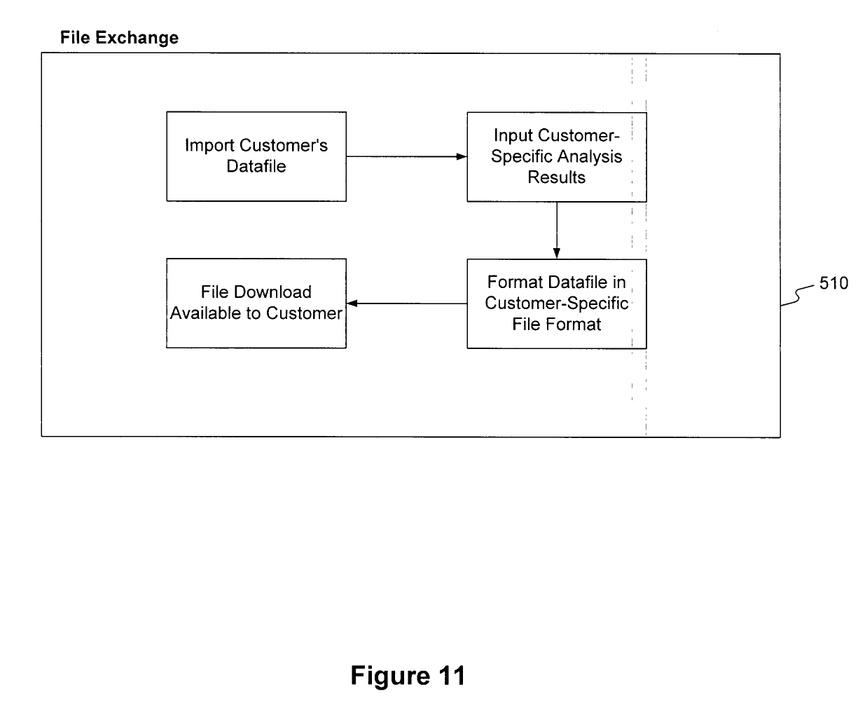

FIG. 11 is a block diagram of a file exchange process consistent with an embodiment of the present invention. Using the file exchange process, analysis service provider 102 may import a customer's datafile, input customer-specific analysis results, such as test results, into the datafile, format the datafile in a customer-specific file format, and make the formatted datafile file available for downloading to the customer. For example, the customer's datafile may be formatted as a spreadsheet using a spreadsheet program, such as Microsoft Excel. File exchange process 510 may further customize the datafile prior to making it available for download to the customer to ensure that the datafile will be operable on the customer's computer system. Customer-specific aspects of file exchange process 510 may be stored, for example, in user preferences 602.

III. Database

FIG. 12 is a block diagram of a database in greater detail, consistent with an embodiment of the present invention. Database 402 may store any data used by analysis service provider 102, including customer data 1200 and industry data 1202. Customer data 1200 may correspond to a plurality of customers. Database 402 may also include, for example, web pages used by customer interface 400, digital certificate software used by security module 404, standard reports used by reporting module 408, and calculations used by analysis module 406 (not shown).

IV. Security

FIG. 13 is a block diagram of a security module in greater detail, consistent with an embodiment of the present invention. Security module 404 may include user authentication information 1300 and general public access information 1302. In this way, members of the general public may access some parts of analysis service provider 102 while only authorized users may access other parts.

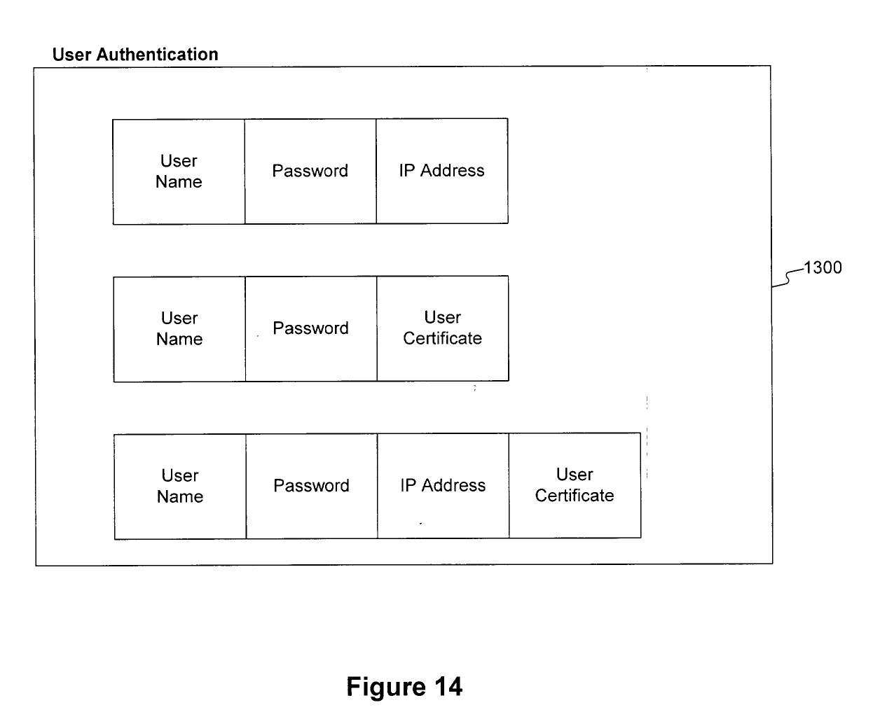

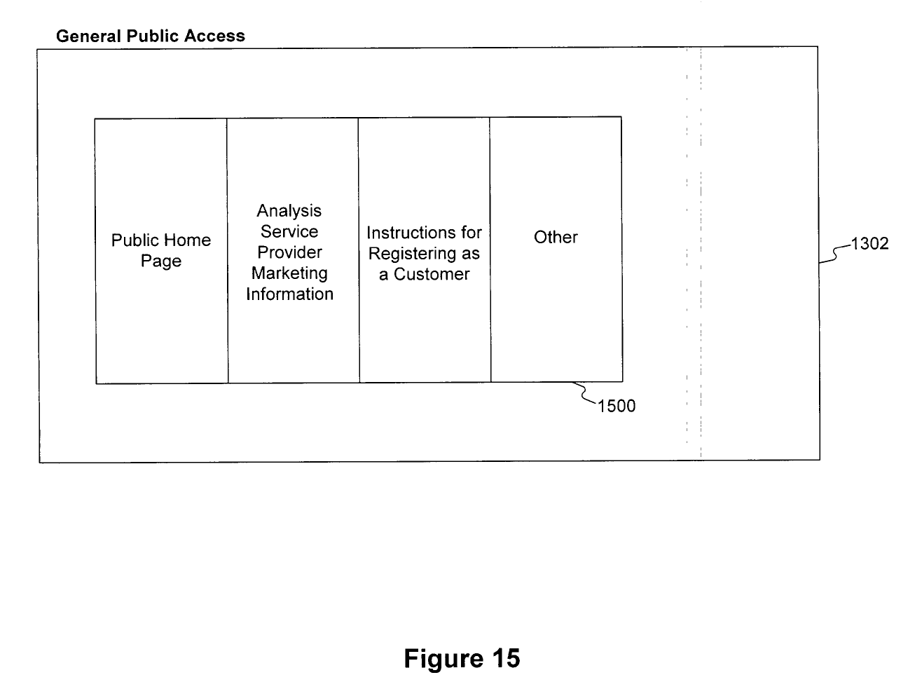

FIG. 14 is a block diagram of user authentication information in greater detail, consistent with an embodiment of the present invention. To ensure security of data used by analysis service provider 102, a user may be authenticated in a number of ways. For example, a user authentication may require a user name, password, and Internet protocol (IP) address. As described above, the IP address may relate to the physical address of the user's computer. The user may also be authenticated, for example, by a user name, password, and user certificate. For greater security, the user may be authenticated with a user name, password, IP address, and user certificate. One skilled in the art will recognize that other user authentication technology may also be implemented by security module 404.

FIG. 15 is a block diagram of general public access information in greater detail, consistent with an embodiment of the present invention. General public access data 1302 may include a list 1500 of items available to the general public. For example, list 1500 may include webpages available to the general public such as a public home page, marketing information, and instructions for registering as a registered customer or user. One skilled in the art will recognize that other items may be included in list 1500 and/or general public access data 1302.

V. Analysis Module

FIG. 16 is a block diagram of an analysis module in greater detail, consistent with an embodiment of the present invention. In an embodiment of the present invention, customers 100 provide samples 200 to analysis service provider 102. Analysis service provider 102 may use analysis module 406 to analyze the samples. Analysis module 406 may include, for example, analysis tools 1600, industry analysis 1602, and customer specific analysis 1604. Once analysis has been performed, customers may view the results in a number of ways using reporting module 408, as described in greater detail below.

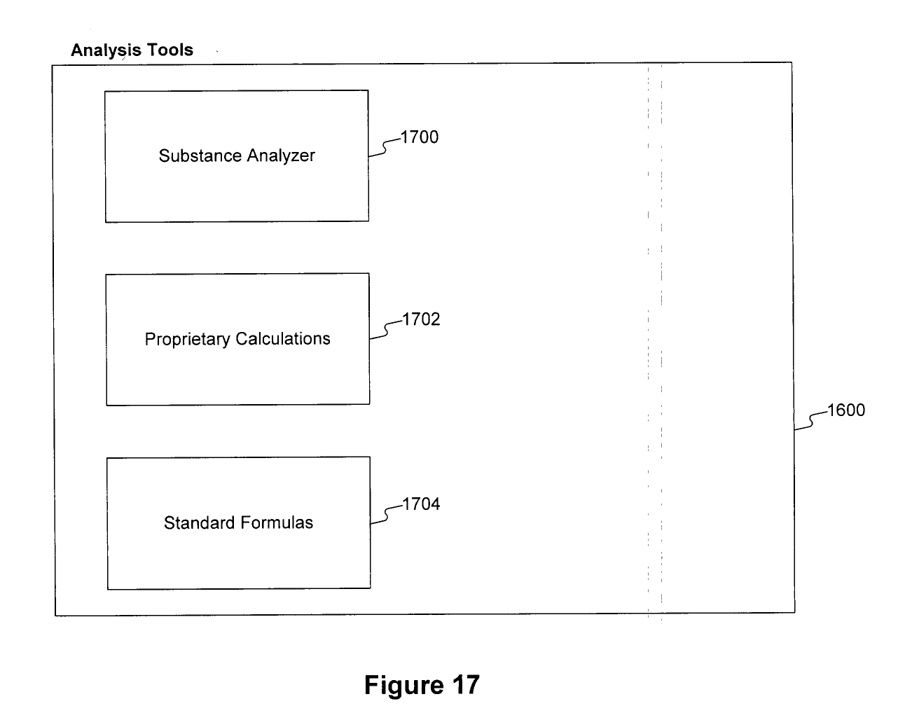

FIG. 17 is a block diagram of analysis tools in greater detail, consistent with an embodiment of the present invention. Analysis tools 1600 may include, for example, a substance analyzer 1700, proprietary calculations 1702, and standard formulas 1704. Substance analyzer 1700 may analyze a substance using proprietary calculations 1702 and standard formulas 1704. In an embodiment of the present invention, the customers may access the results of the analysis without having access to proprietary calculations 1702.

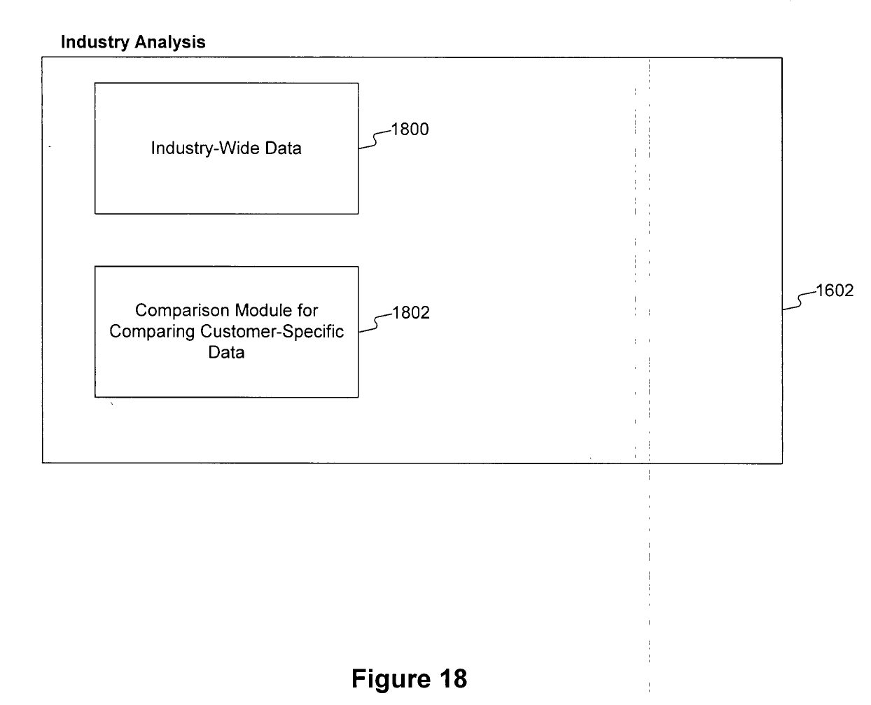

FIG. 18 is a block-diagram of industry analysis in greater detail, consistent with an embodiment of the present invention. Industry analysis 1602 may include, for example, industry-wide data 1800 and a comparison module for comparing customer-specific data 1802. For example, when customers submit samples for testing, the test results may be stored in industry-wide data 1800. In addition to analysis of individual customers' test results, all of the test results may be analyzed to produce an industry-wide analysis, such as an industry average or industry mean, also stored in industry-wide data 1800. A customer may then use comparison module 1802 to compare its own test results to those of others in a given industry or to industry-wide results.

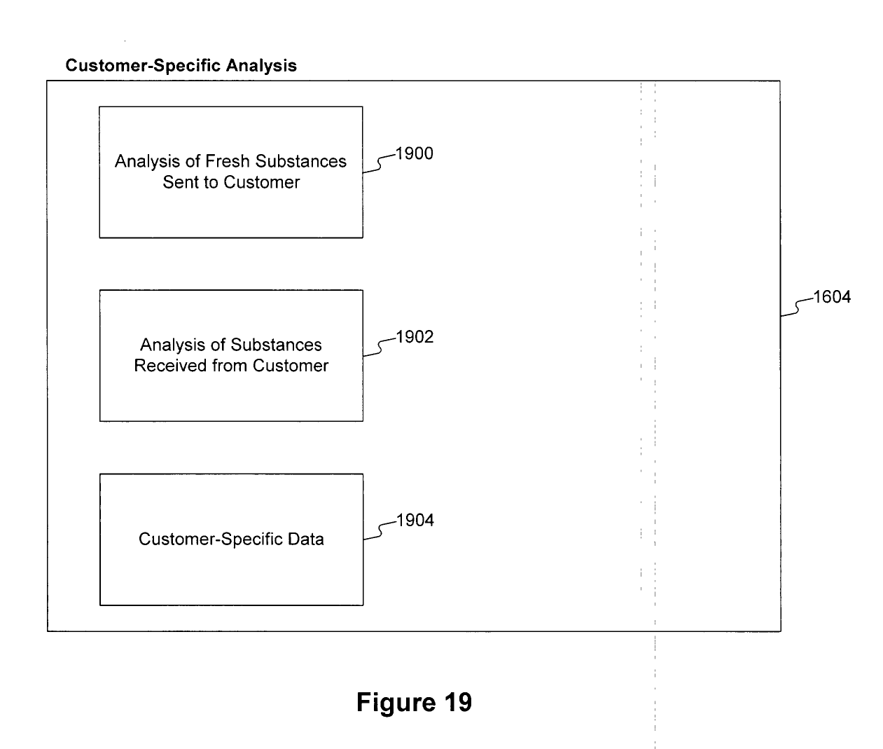

FIG. 19 is a block diagram of customer-specific analysis in greater detail, consistent with an embodiment of the present invention. Customer-specific analysis 1604 may include an analysis of fresh substances sent to a customer 1900, an analysis of substances received from the customer 1902, and other customer-specific data 1904. A fresh substance is a substance, such as a substance purchased by a customer, that is analyzed when it is new. One skilled in the art will recognize that customer-specific analysis 1604 may include other analysis, such as analysis of products purchased by customer 1902.

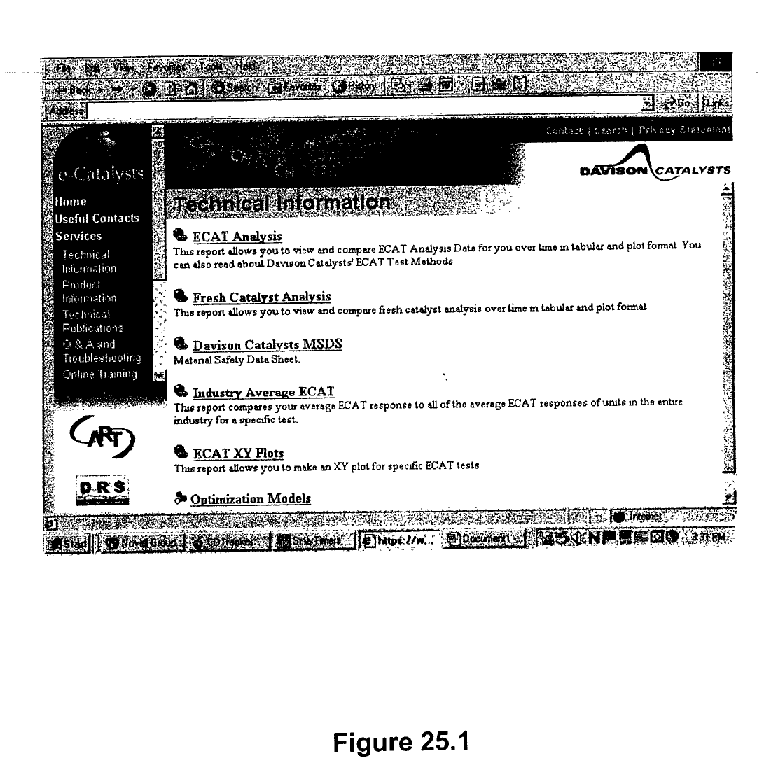

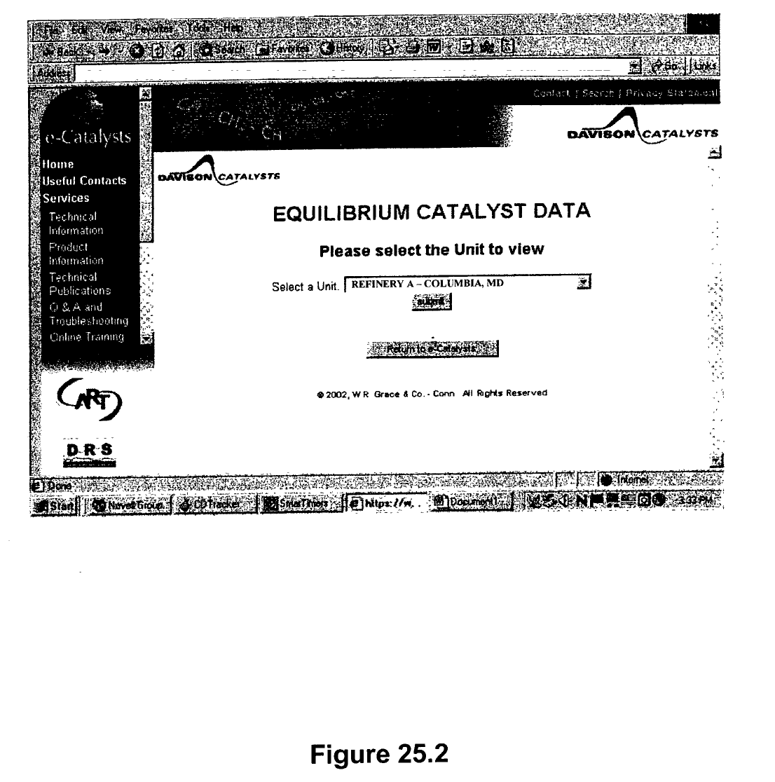

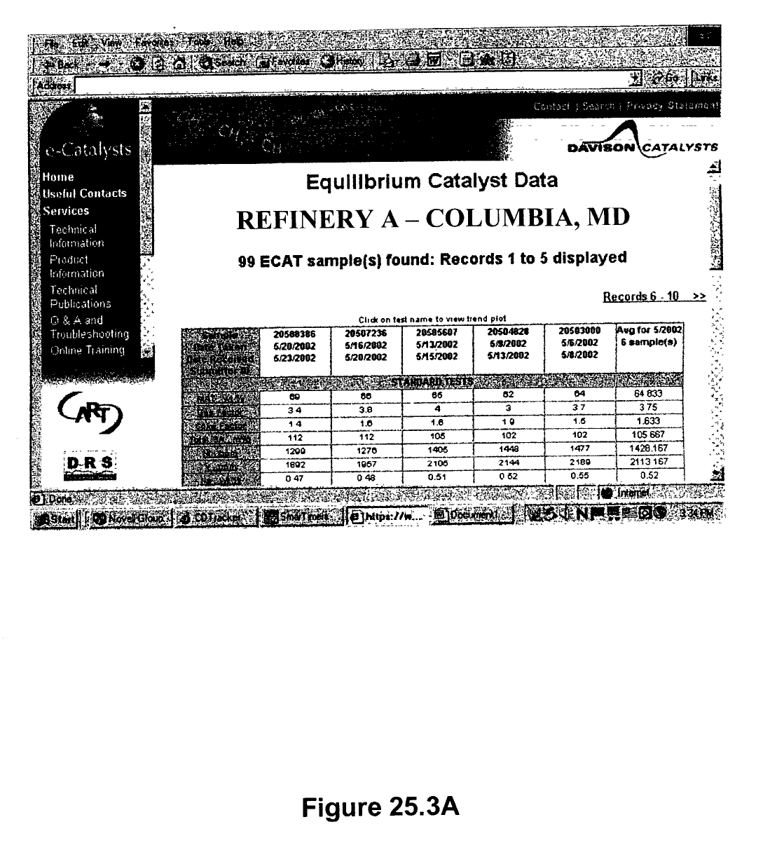

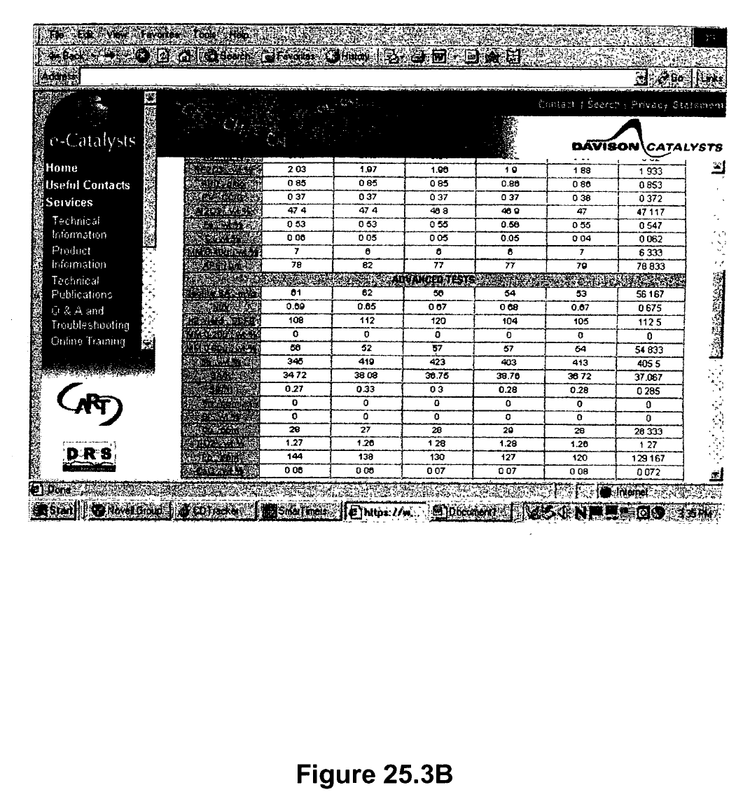

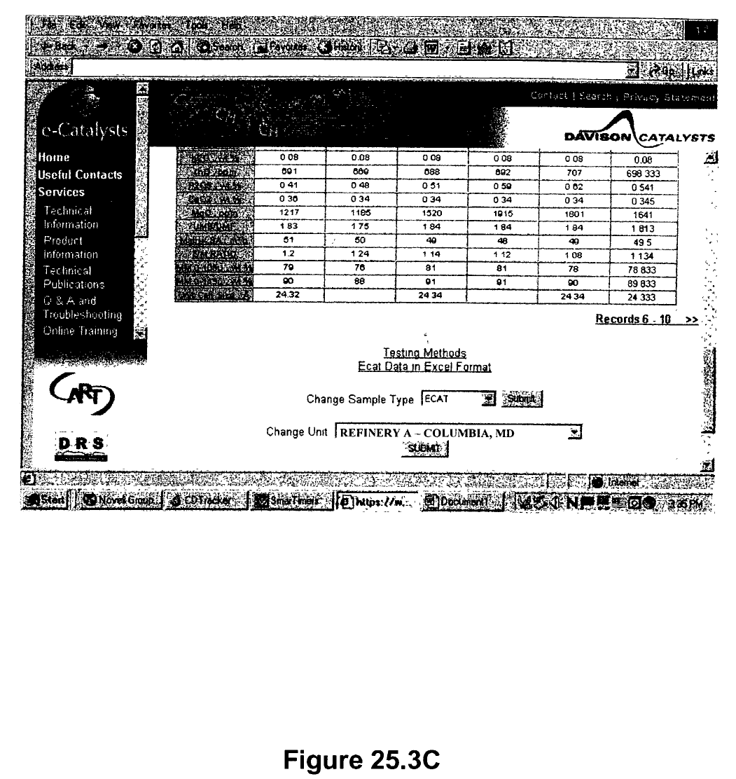

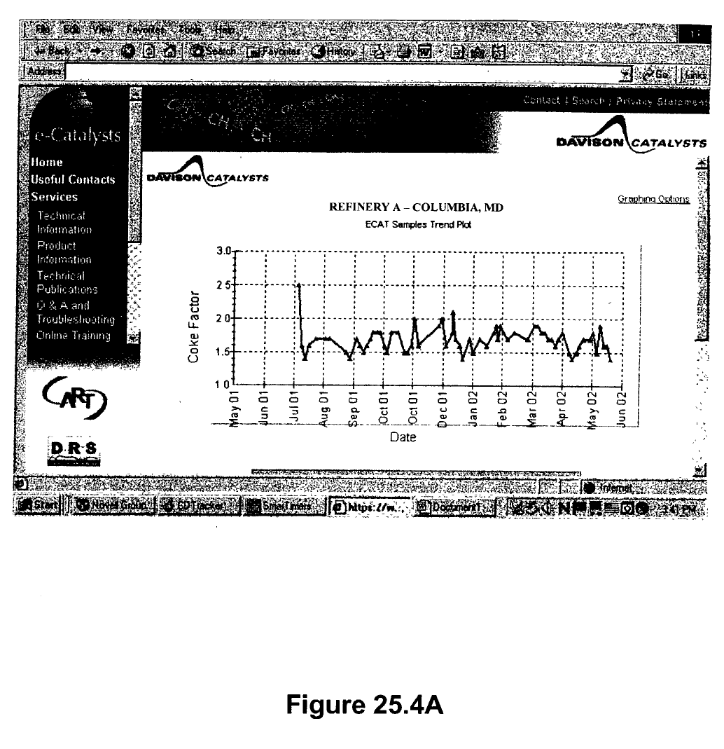

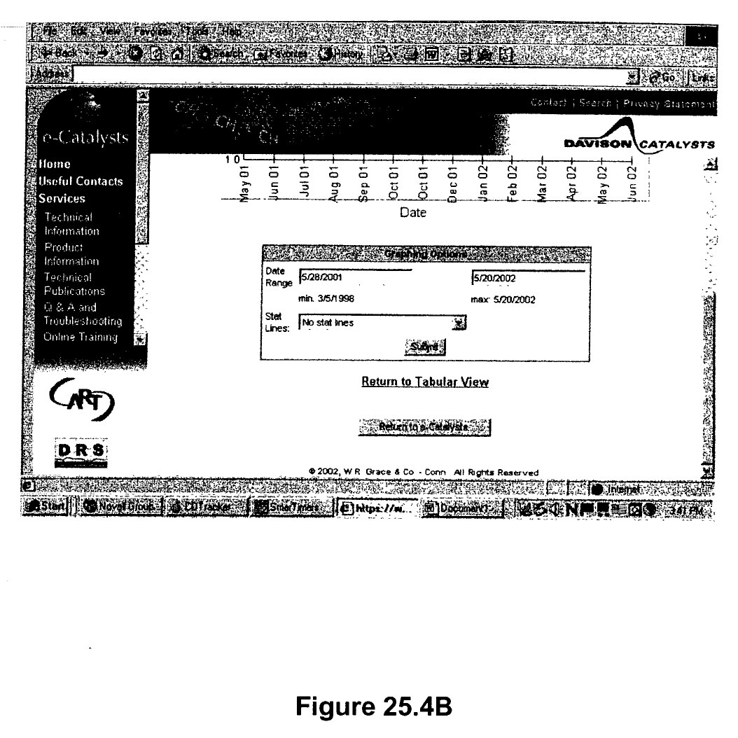

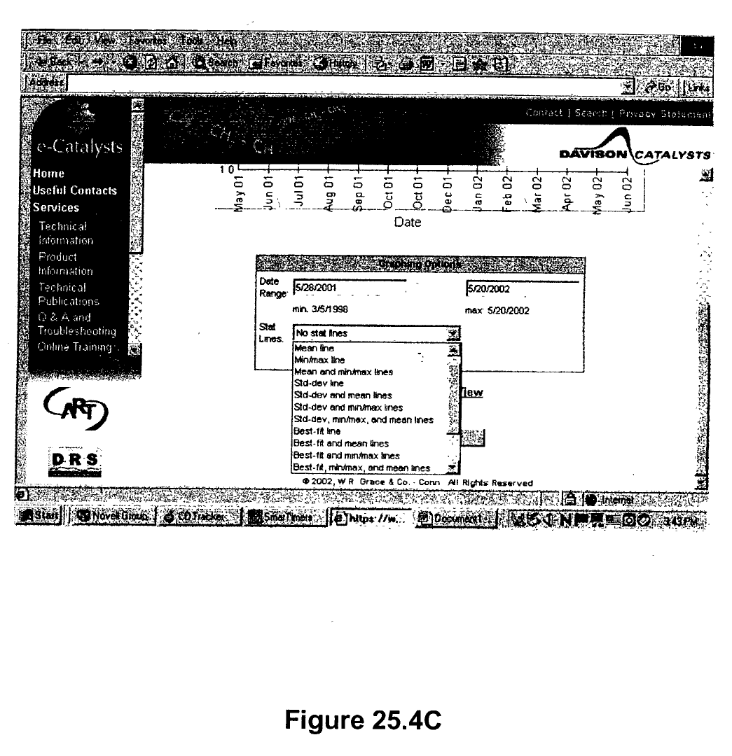

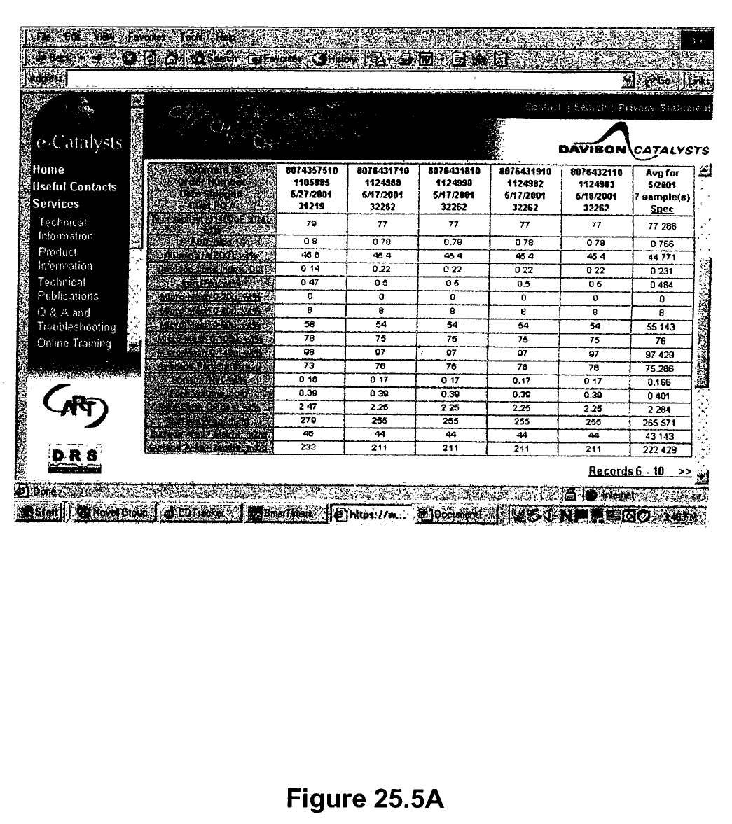

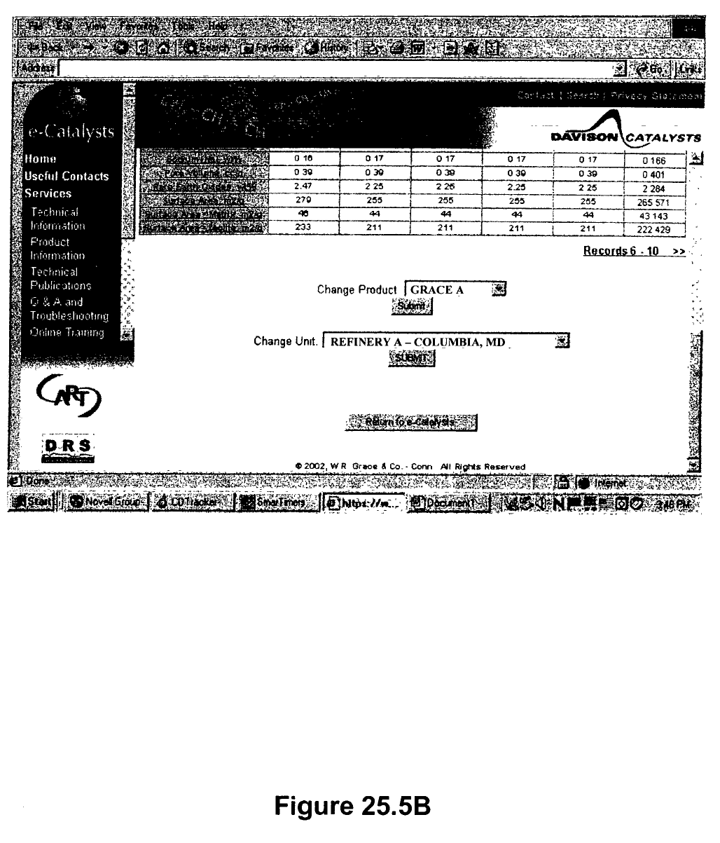

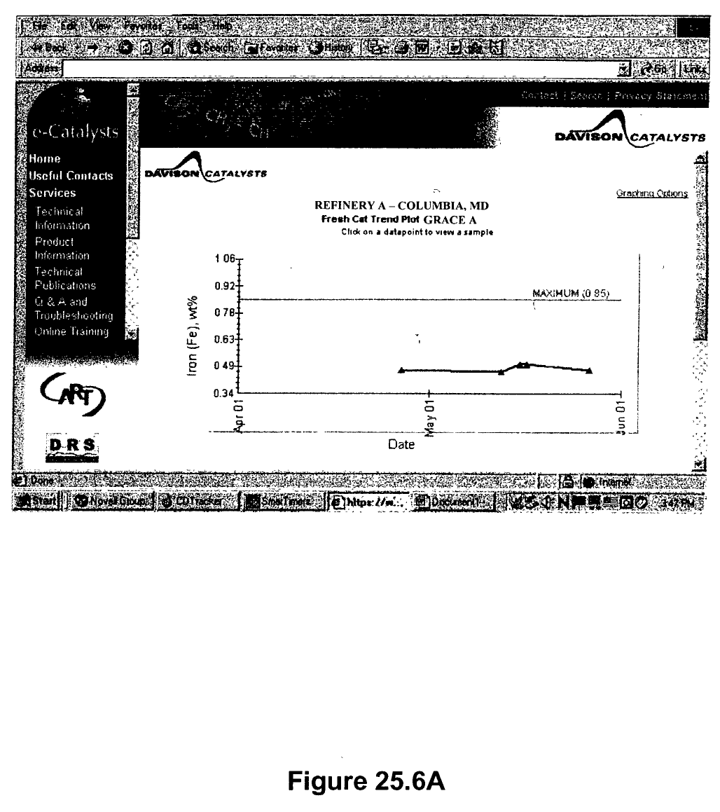

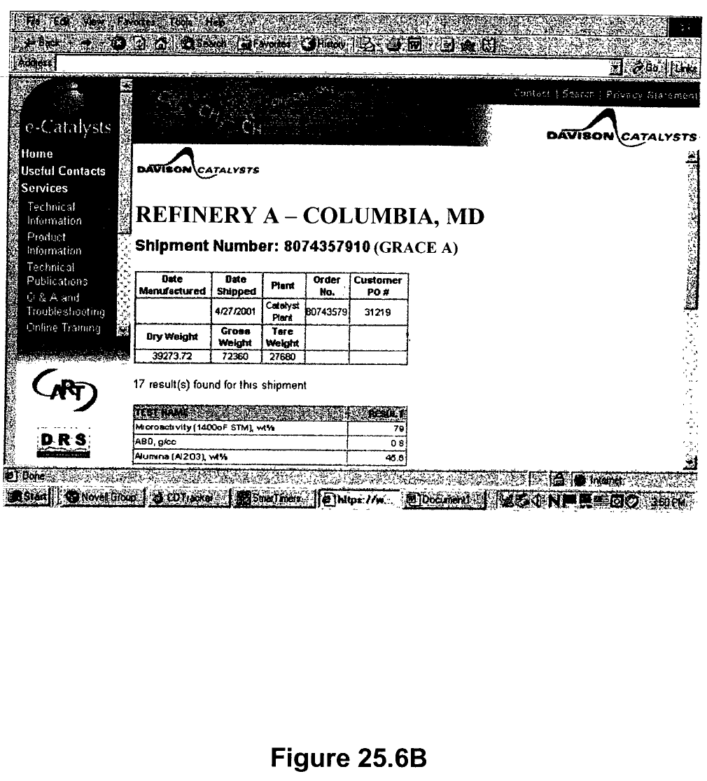

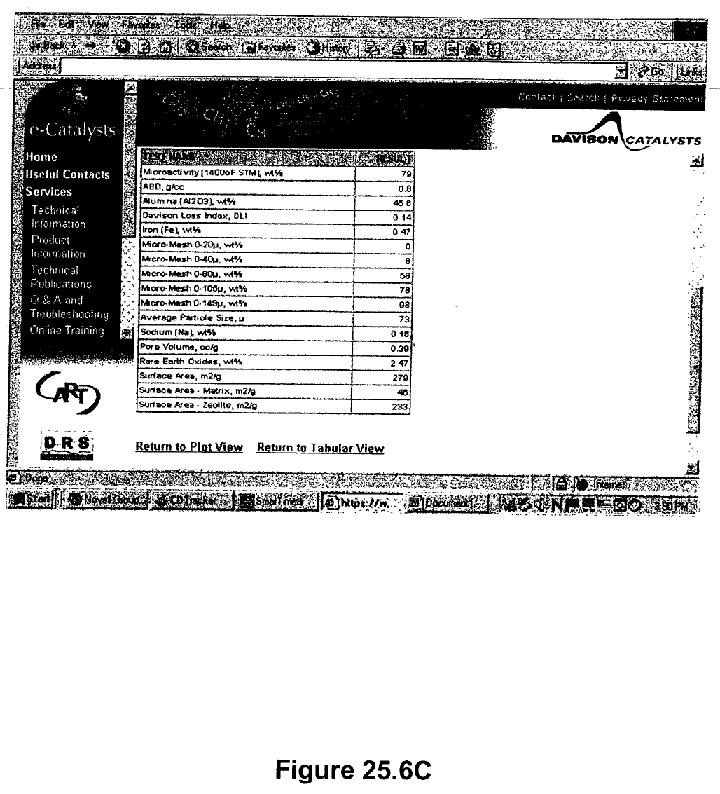

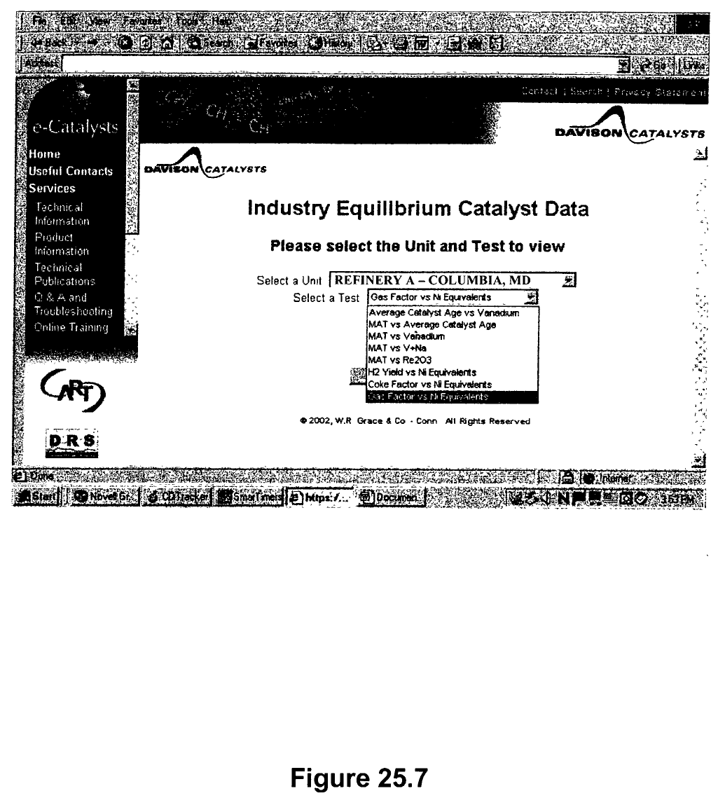

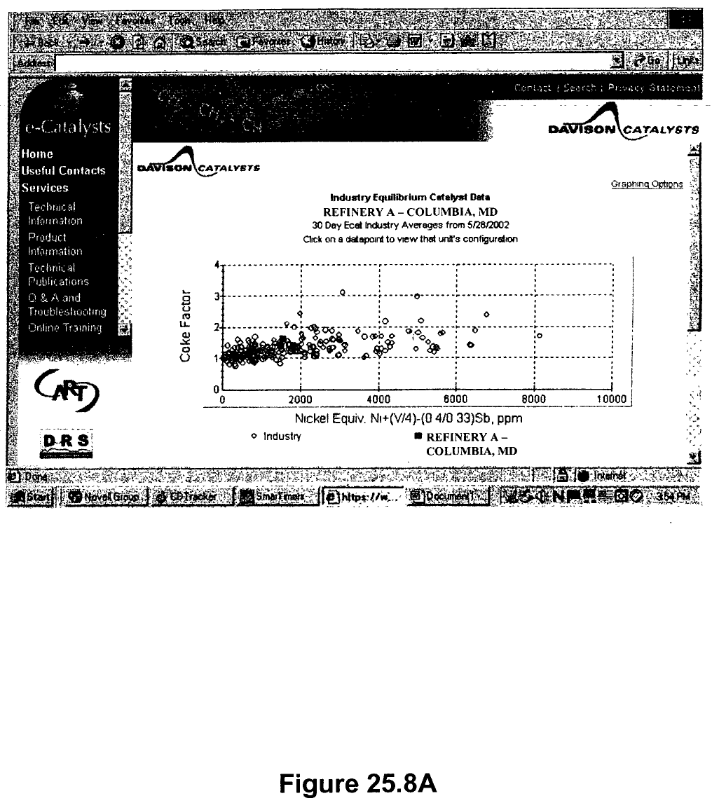

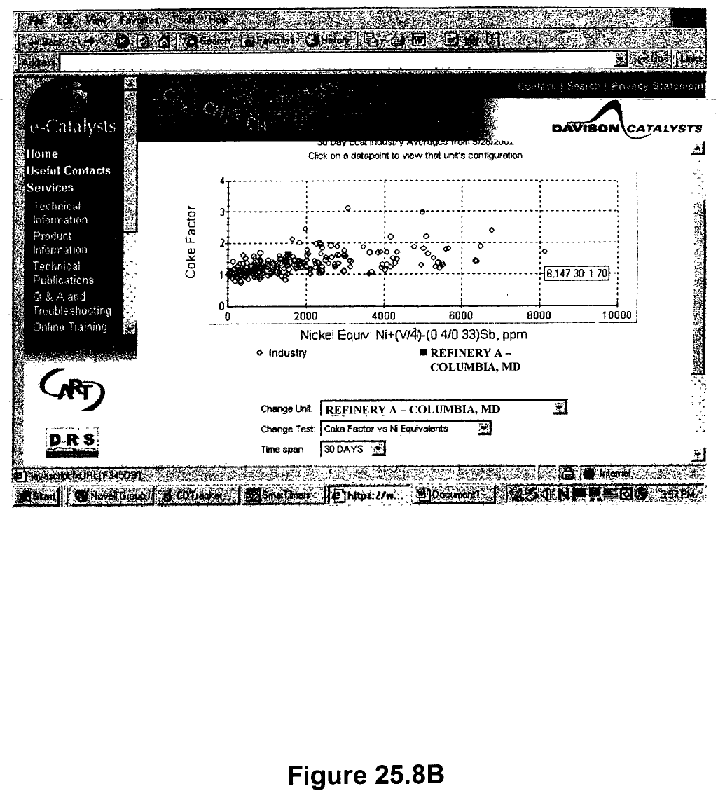

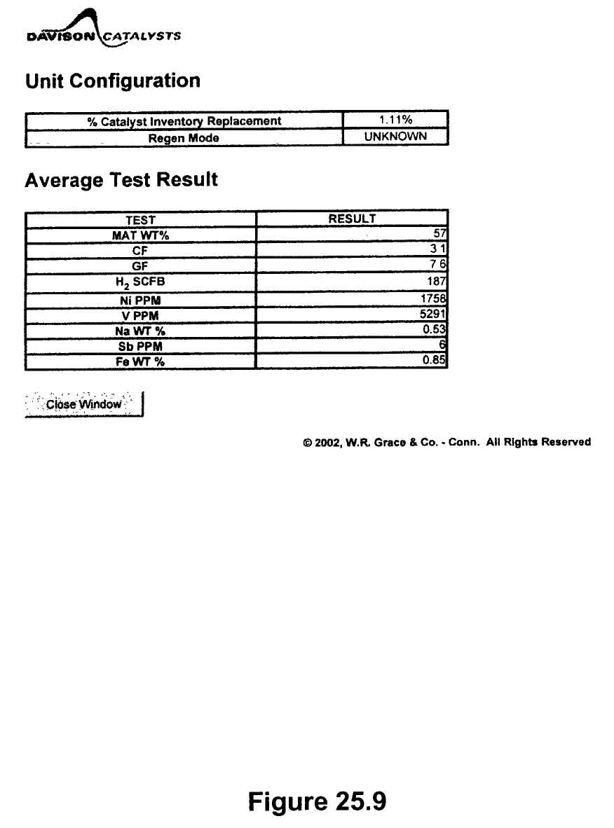

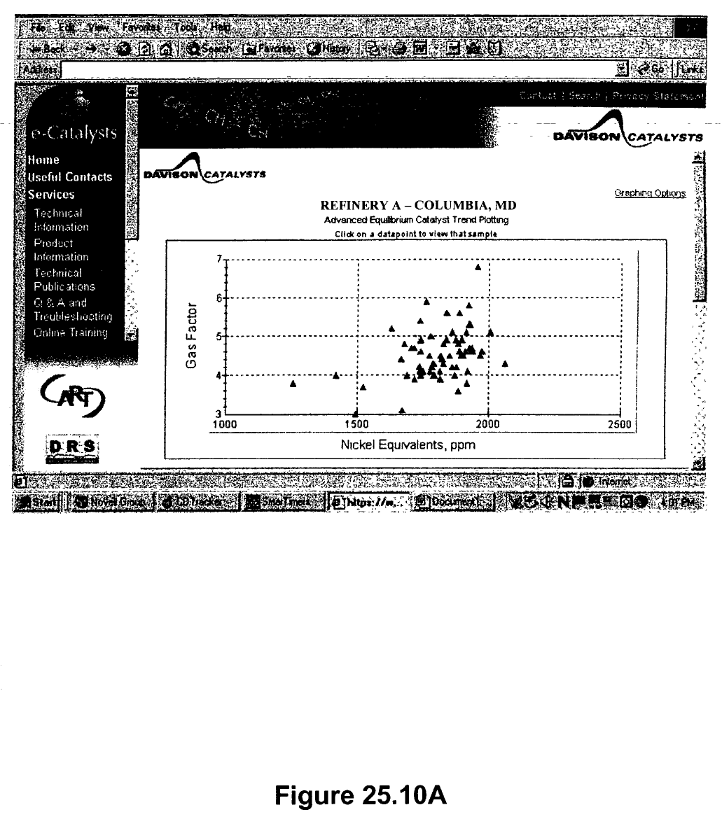

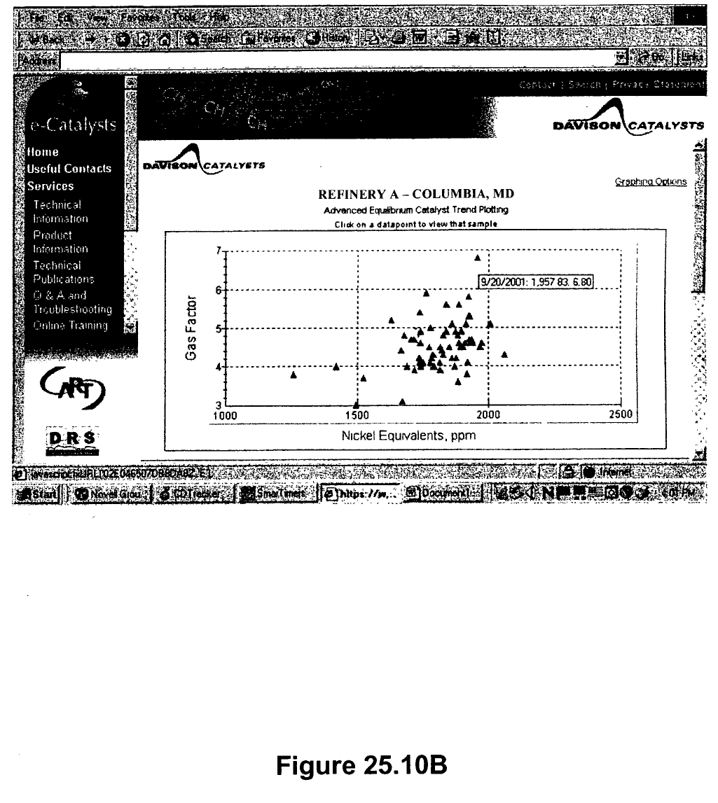

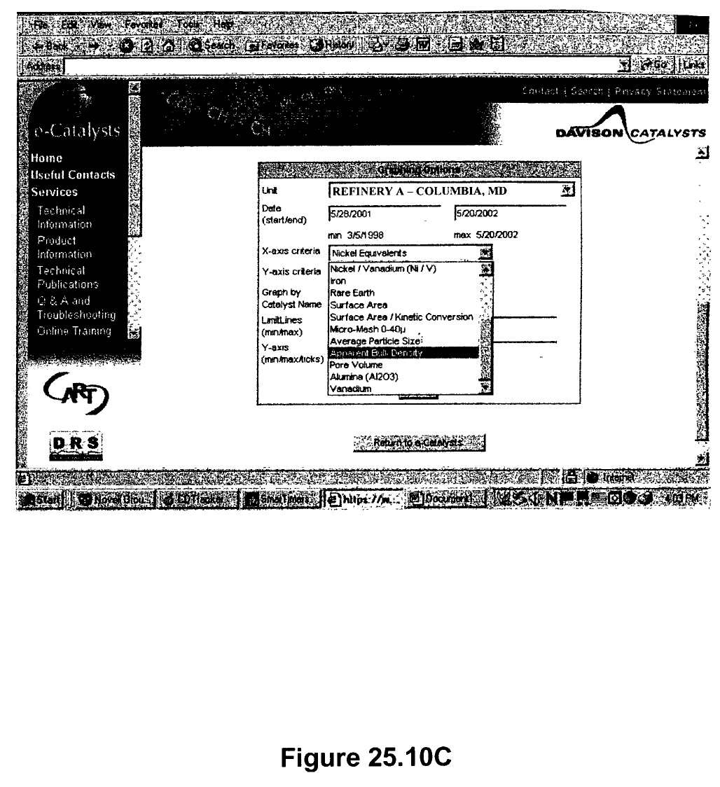

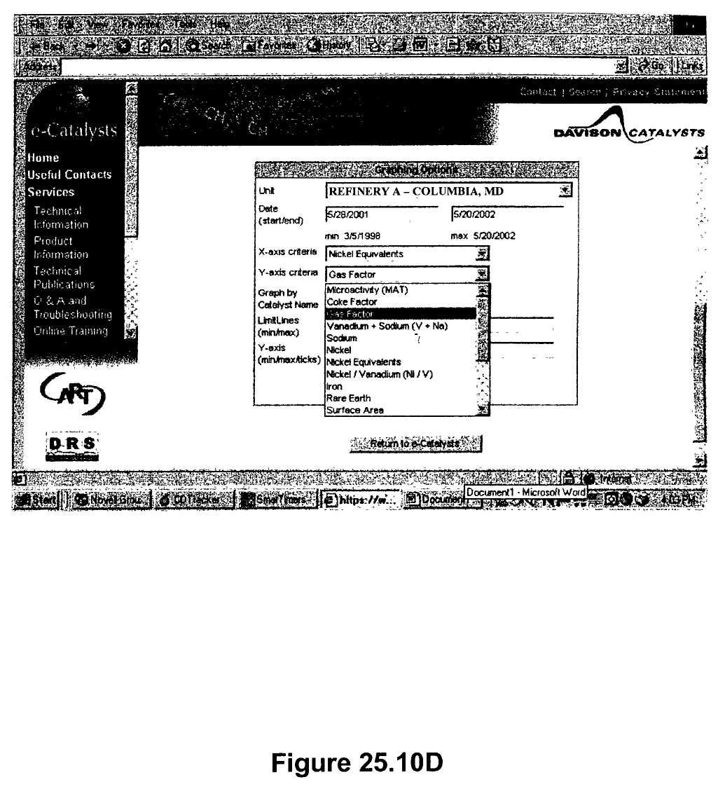

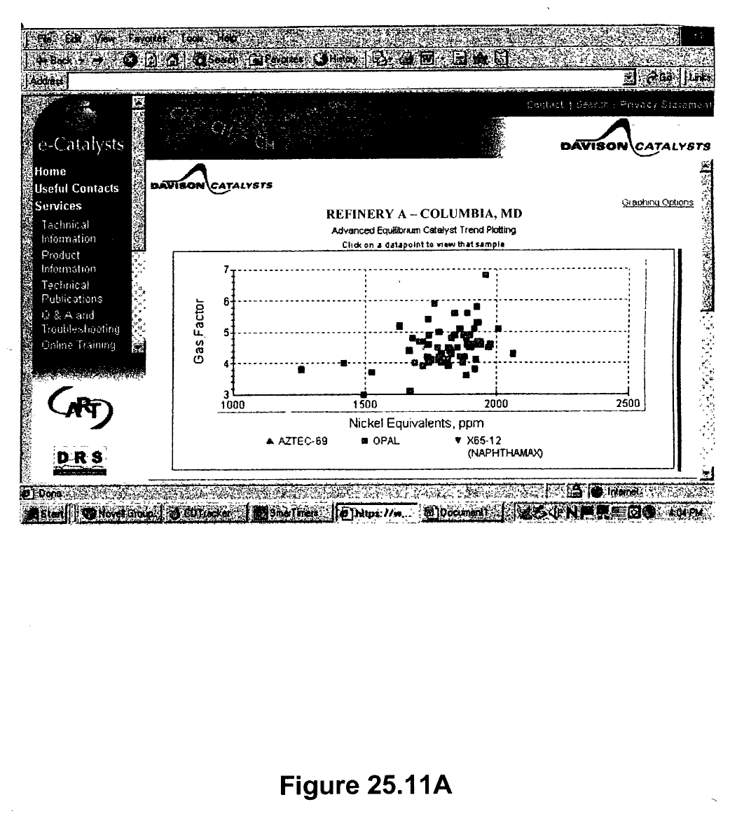

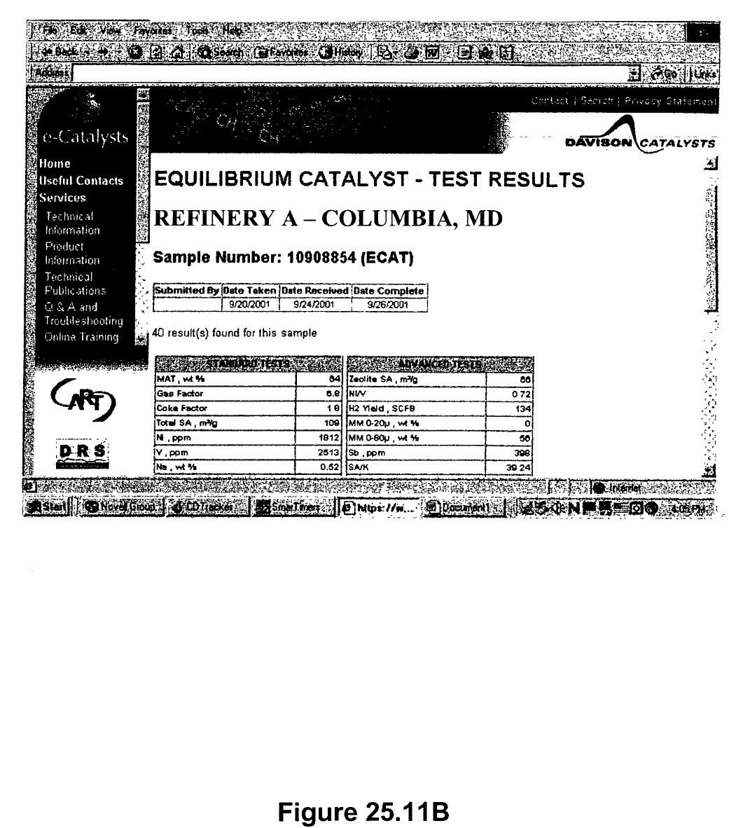

A detailed example of analysis consistent with an embodiment of the present invention is described below with reference to FIGS. 25.1-25.10.

VI. Reporting Module

FIG. 20 is a block diagram of a reporting module in greater detail, consistent with an embodiment of the present invention. Reporting module 408 may include, for example, report generator 2000, interface for viewing reports 2002, user reports 2004, and report formats 2006. Reporting module 408 may be used to generate, store, and display reports based on analysis performed by analysis module 406, as described in greater detail in above.

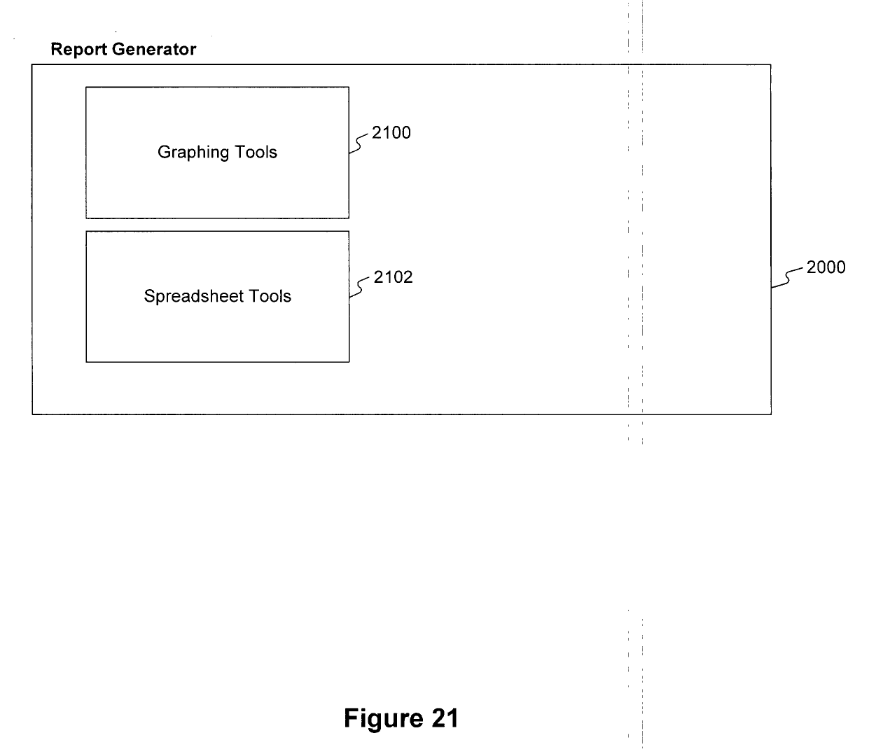

FIG. 21 is a block diagram of a report generator in greater detail, consistent with an embodiment of the present invention. Report generator 2000 may be used to generate reports based on the results of analysis performed by analysis module 406. Report generator 2000 may include, for example, graphing tools 2100, such as X-Y plotting tools, and spreadsheet tools 2102, such as Microsoft Excel or other spreadsheet software.

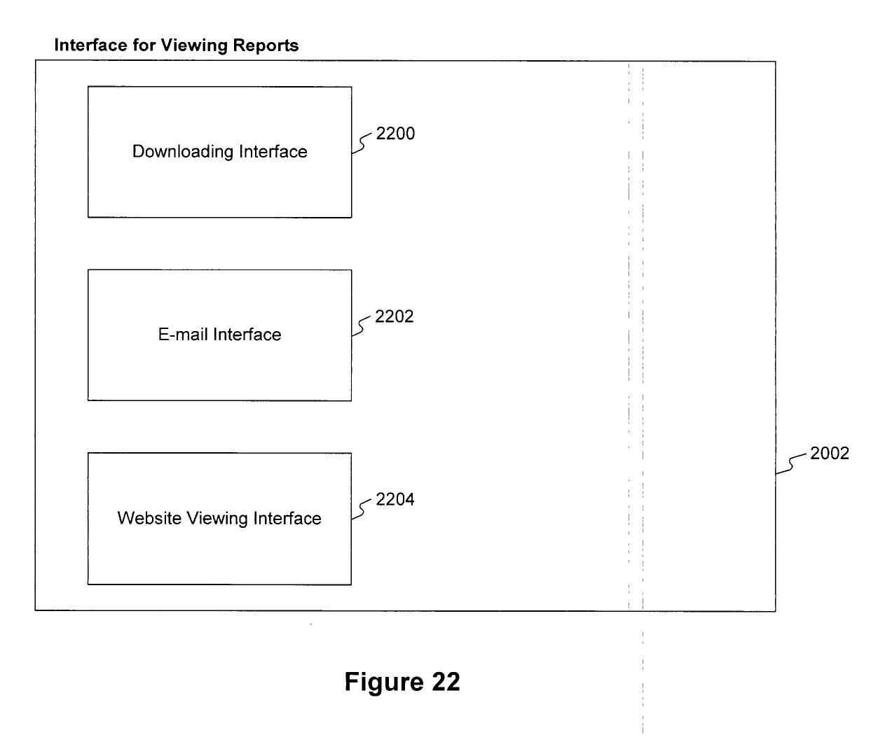

FIG. 22 is a block diagram of an interface for viewing reports in greater detail, consistent with an embodiment of the present invention. Interface for viewing reports 2002 may include, for example, a downloading interface 2200, an e-mail interface 2202, and a website viewing interface 2204. In this way, the user may download reports using download interface 2200, may request receiving reports by e-mail using e-mail interface 2202, and/or may view reports on the website using website viewer 2204.

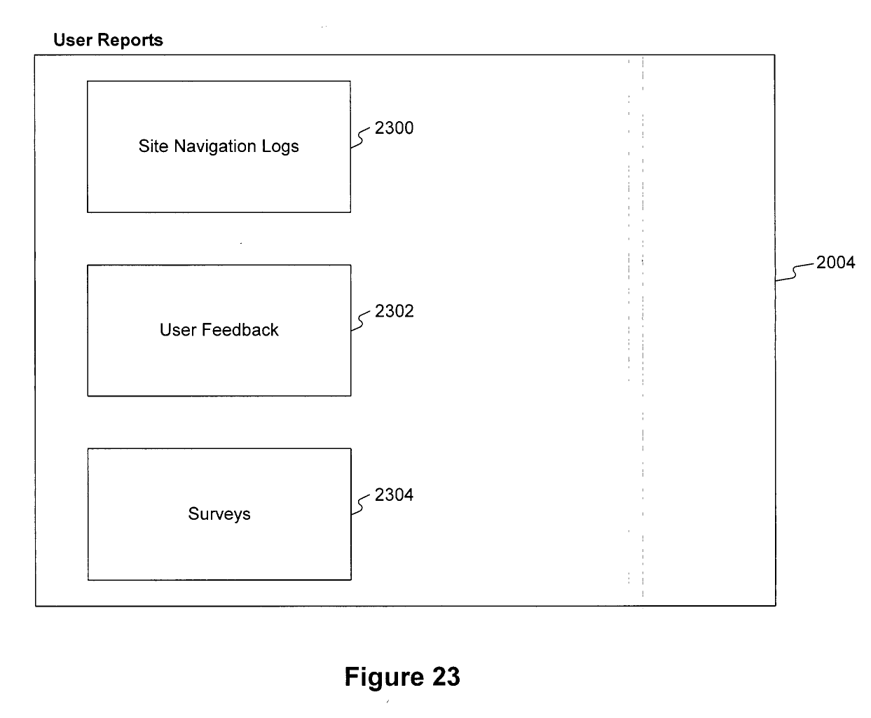

FIG. 23 is a block diagram of user reports 2004 in greater detail, consistent with an embodiment of the present invention. User reports 2004 may include, for example, site navigation logs 2300, user feedback 2302, and surveys 2304. Site navigation logs 2300 may track and store the ways in which users navigate the analysis service provider's website. User feedback 2302 may include user compliments or complaints. Surveys 2304 may include the results of customer or other surveys.

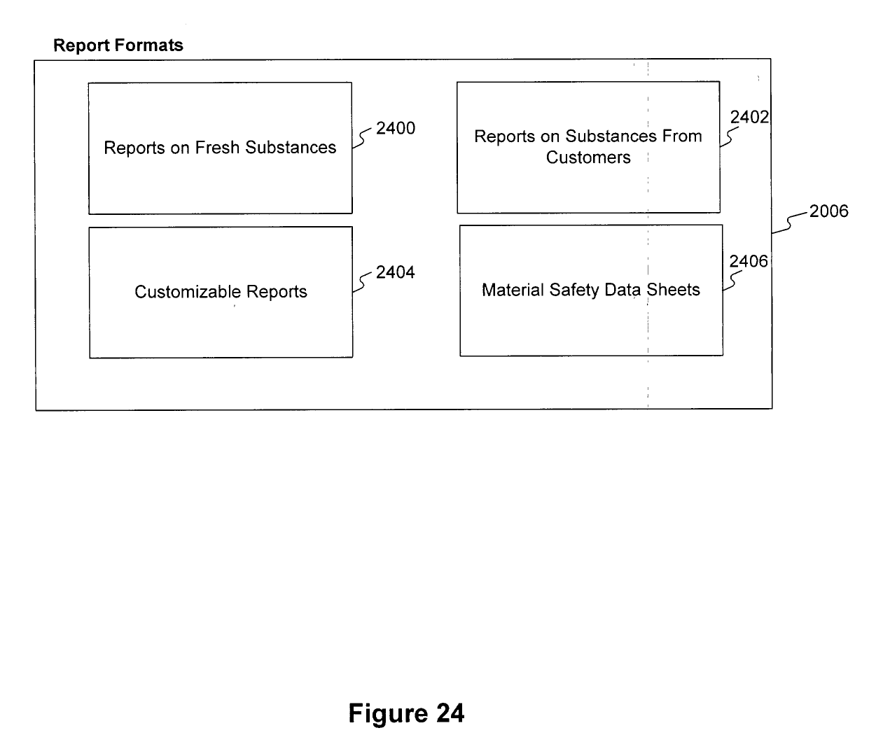

FIG. 24 is a block diagram of report formats in greater detail, consistent with an embodiment of the present invention. Report formats 2006 may include, for example, reports on fresh substances 2400, reports on substances from customers 2402, customizable reports 2404, and material safety data sheets 2406. Report formats 2006 may include standard report templates that are used to produce customer-specific reports. Reports on fresh substances 2400 may include data about substances that are analyzed when they are new. Reports on substances from customers 2402 may include data about used substances received from a customer. Customizable reports 2404 may enable a customer to specify aspects of a report, such as date ranges or axis values. Material data safety sheets 2406 may include safety data about a product. This safety data may include, for example, an emergency contact, a trade name, chemical information, ingredients, first aid, toxicology report, typical chemical and physical information, handling information or other safety information about different products and substances.

A detailed example of sample reporting consistent with an embodiment of the present invention is described below with reference to FIG. 25.

VII. Sample Analysis and Reporting

FIG. 25.1 is a sample technical information page for a website consistent with an embodiment of the present invention. The technical information page may display various information available to a user. This information may be produced, for example, by analysis module 406 and reporting module 408. Technical information may include, for example, customer-specific analysis data, fresh substance analysis data, material safety data sheets, industry average reports, plotting tools, and optimization models. The data may relate to analysis of catalysts or any other type of substance. Optimization models may include, by way of example only, calculation templates for a variety of tests, including metals, heat balance, and undercutting value. These models may enable a user to input information, such as a catalyst name, and other data into an automatic calculator that will determine a target test result.

FIG. 25.2 is a sample customer-specific analysis page for a website consistent with an embodiment of the present invention. The customer-specific analysis page may be presented, for example, when a user chooses to view customer-specific analysis data from the technical information page. The customer-specific analysis page may prompt the user to select a unit for which to view customer-specific analysis data. The units listed in a drop-down list may be, for example, different departments or plants corresponding to a customer. Once the user selects a unit, a customer-specific report for that unit is presented. Alternatively, a user may not be prompted to select a unit if only one unit is available for viewing and the customer-specific report for that unit may automatically be displayed.

FIG. 25.3 is a sample customer-specific report for a website consistent with an embodiment of the present invention. The customer-specific report may include, for example, data produced by substance analyzer 1700 and stored as customer-specific analysis 1604. The data may be formatted, for example, by report generator 2000 and stored in user reports 2004. The customer-specific report may be generated using a standard report format 2006.

As shown in FIG. 25.3, the customer-specific report may be presented, for example, in a table format listing data for any number of tests run on a sample substance. For each sample, the table may include fields for sample number, date taken, date received by the analysis service provider, and submitter ID. For each sample, a number of test results may be displayed, such as gas factor and coke factor. The customer-specific report may span several pages. This report may also include, for example, a link to enable the user to view the data in an alternative format, such as in a Microsoft Excel format. To present the data in an alternative format, report generator 2000 may use, for example, spreadsheet tools 2102 or graphing tools 2100. The customer-specific report may also include links for the user to view testing methods or to change the types of samples displayed. By selecting a testing methods link, the user may view a testing methods document to inform the user about how tests are performed. The user may view analyses for different types of samples, such as fresh substances, i.e., substances purchased by a customer that are analyzed when they are new.

FIG. 25.4 is a sample test detail report for a website consistent with an embodiment of the present invention. To further facilitate the user's viewing of analysis data, each sample or other data item included in a customer-specific report may be displayed as a link. The user may select a data item link to display a test detail report with more detailed analysis about that specific test. For example, clicking on the “Coke Factor” test link in FIG. 25.3 may display the test detail report of FIG. 25.4.

The test detail report may include a trend plot to show sample analysis over time for a specific test (e.g., Coke Factor). In addition to a standard trend plot or other graph, the user may be given graph options, such as a specified date range or the inclusion of statistical lines. The statistical lines options may include, by way of example only, a mean line, a min/max line, a standard deviation line, and a best fit line. These options may be presented to the user, for example, using drop-down lists. Once a user selects graphing options, report generator 2000 may recreate the graph to include the additional statistical lines or other options chosen by the user.

FIG. 25.5 is a sample fresh substance analysis page for a website consistent with an embodiment of the present invention. Fresh substances may be, for example, substances purchased by a customer that are analyzed when they are new. The fresh substance analysis page may include, for example, a shipment ID number, order number, date shipped, and customer purchase order number. For each fresh substance listed, the fresh substance analysis page may include the results of any number of tests, such as Microactivity. The fresh substance analysis page may also include a drop-down list to enable the user to change a product or a unit and view data related to the chosen product or unit. In this way, the user may easily navigate among, for example, analysis data for different units within a single customer or different products purchased by the customer.

FIG. 25.6 is a sample fresh substance test detail report for a website consistent with an embodiment of the present invention. To further facilitate the user's viewing of analysis data, each sample or other data item included in a fresh substance analysis report may be displayed as a link. The user may select a data item link to display a fresh substance test detail report with more detailed analysis about that specific test. For example, clicking on the “Iron (Fe)” test link in FIG. 25.5 may display the fresh substance test detail report of FIG. 25.6.

The fresh substance test detail report may include a trend plot to show sample analysis over time for a specific test (e.g., Iron percentage). In addition to a standard trend plot or other graph, the user may be given graph options, such as a specified date range or the inclusion of statistical lines. The statistical lines options may include, by way of example only, a mean line, a min/max line, a standard deviation line, and a best fit line. These options may be presented to the user, for example, using drop-down lists. Once a user selects graphing options, report generator 2000 may recreate the graph to include the additional statistical lines or other options chosen by the user.

Within the fresh substance test detail report, each data item may be a link to additional information about the fresh substance. Selecting a link may display, for example, shipment information about the corresponding sample. The shipment information may include, for example, the shipment number, the product, the date manufactured, the date shipped, the plant, the customer purchase order number, the dry weight, the gross weight, and the tare weight. The shipment information may also include a table of test results, listing tests performed and results for that particular shipment. The shipment information display may also include links to allow the user to easily move back to the plot graph or the tabular graph.

FIG. 25.7 is a sample industry analysis page for a website consistent with an embodiment of the present invention. The industry analysis page may be presented, for example, when a user chooses to view industry analysis data from the technical information page (see FIG. 25.1). The industry analysis page may prompt the user to select a unit and/or a test for which to view industry analysis data. The units listed in a drop-down list may be, for example, different departments or plants corresponding to a customer. The tests listed in a drop-down list may be, for example, different comparisons such as Gas Factor versus Nickel Equivalents. Once the user selects a unit and/or a test, an industry report for that unit is presented. Alternatively, a user may not be prompted to select a unit if only one unit is available for viewing and the industry report for that unit may automatically be displayed.

FIG. 25.8 is a sample industry report for a website consistent with an embodiment of the present invention. The industry report may include, for example, data produced by substance analyzer 1700 and stored as industry analysis 1602. The data may be formatted, for example, by report generator 2000 and stored in user reports 2004. The industry report may be generated using a standard report format 2006.

As shown in FIG. 25.8, the industry report may be presented, for example, as a graph including data points showing results of a specific comparison test for samples received from various customers in an industry. In this way, a user may see how the user's test results compare with test results of the industry. The industry report may span several pages. This report may also include, for example, links for the user to change the unit or test displayed. The data points in the industry report may include detailed information that may be viewed by placing a mouse over a data point.

FIG. 25.9 is a sample comparison detail report for a website consistent with an embodiment of the present invention. To further facilitate the user's viewing of industry analysis data, each data point included in the industry report may be displayed as a link. The user may select a data point link to display a comparison detail report with more detailed analysis about that specific comparison. The comparison detail report may include a table corresponding to a sample including the unit configuration of the unit from which the sample came and average test results for the sample.

FIG. 25.10 is a sample advanced substance analysis report for a website consistent with an embodiment of the present invention. From the technical information menu (see FIG. 25.1), a user may choose advanced substance analysis data to display an advanced substance analysis report. The user may be presented with a drop-down list if data for more than one unit is available. Once a unit is selected by the user, an advanced substance analysis report is presented. Each data point may include additional information that can viewed by placing the mouse over the data point.

As part of advanced substance analysis, the user may be given a variety of graphing options, including unit, start and end dates, X-axis criteria, Y-axis criteria, graph by catalyst name, minimum/maximum limits, and Y-axis minimum/maximum limits. In this way, a user may customize the way in which data is viewed. The X-axis criteria may include, by way of example only, nickel equivalents, iron, rare earth, and surface area. The Y-axis criteria may be the same or different from the X-axis criteria and may include, by way of example only, coke factor and microactivity.

FIG. 25.11 is a sample advanced substance analysis by catalyst report for a website consistent with an embodiment of the present invention. The advanced substance analysis by catalyst report may be displayed if a user chooses to graph by catalyst name from the advanced substance analysis report. This catalyst reports includes data for one or more catalysts for given criteria (shown on the X-axis and Y-axis of the graph). By clicking on a data point corresponding to a sample result, the user may view more information about the sample in a detailed report. The detailed report may include, for example, a sample number, a submitted by field, the date the sample was taken, the date the sample was received, and the date the tests were complete. The test results be organized according to, for example, standard and advanced testing.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing information to a customer, comprising the steps of:
receiving a substance from the customer;
analyzing the substance;
storing results of the analysis of the substance in a database; and
allowing the customer to access the results of the analysis of the substance stored in the database via a network.

2. The method of claim 1, wherein the allowing step further comprises the substeps of:
authenticating a user representing the customer; and
enabling the authenticated user to access the results of the analysis via the network.

3. The method of claim 1, further comprising the step of:
generating a customer-specific report containing the results of the analysis of the substance.

4. The method of claim 1, further comprising the step of:
generating an industry comparison report containing results of the analysis of the substance compared with industry data.

5. The method of claim 1, further comprising the steps of:
receiving an order for a new substance from the customer;
analyzing the new substance; and
allowing the customer to access results of the analysis of the new substance via the network.

6. The method of claim 1, wherein the allowing step further comprises the substep of:
enabling the customer to download the results of the analysis.

7. The method of claim 1, wherein the allowing step further comprises the substep of:
enabling the customer to view the results of the analysis using a Web browser.

8. The method of claim 1, wherein the allowing step further comprises the substep of:
sending the results of the analysis to the customer via e-mail.

9. The method of claim 1, further comprising the step of:
providing a service to the customer via the network.

10. The method of claim 9, wherein the service includes a library of technical references.

11. The method of claim 9, wherein the service includes product ordering.

12. The method of claim 9, wherein the service includes troubleshooting.

13. The method of claim 1, wherein the substance is a used catalyst.

14. The method of claim 1, wherein the substance is a new catalyst.

15. A system for providing information to a customer, comprising:
a first receiving component configured to receive a substance from the customer;
a first analyzing component configured to analyze the substance;
a storing component configured to store results of the analysis of the substance in a database; and
a first allowing component configured to allow the customer to access the results of the analysis of the substance stored in the database via a network.

16. The system of claim 15, wherein the first allowing component further comprises:
an authenticating component configured to authenticate a user representing the customer; and
a first enabling component configured to enable the authenticated user to access the results of the analysis via the network.

17. The system of claim 15, further comprising:
a first generating component configured to generate a customer-specific report containing the results of the analysis of the substance.

18. The system of claim 15, further comprising:
a second generating component configured to generate an industry comparison report containing results of the analysis of the substance compared with industry data.

19. The system of claim 15, further comprising:
a second receiving component configured to receive an order for a new substance from the customer;
a second analyzing component configured to analyze the new substance; and
a second allowing component configured to allow the customer to access results of the analysis of the new substance via the network.

20. The system of claim 15, wherein the first allowing component further comprises:
a second enabling component configured to enable the customer to download the results of the analysis.

21. The system of claim 15, wherein the first allowing component further comprises:
a third enabling component configured to enable the customer to view the results of the analysis using a Web browser.

22. The system of claim 15, wherein the first allowing component further comprises:
a sending component configured to send the results of the analysis to the customer via e-mail.

23. The system of claim 15, further comprising:
a providing component configured to provide a service to the customer via the network.

24. The system of claim 23, wherein the service includes a library of technical references.

25. The system of claim 23, wherein the service includes product ordering.

26. The system of claim 23, wherein the service includes troubleshooting.

27. The system of claim 15, wherein the substance is a used catalyst.

28. The system of claim 15, wherein the substance is a new catalyst.

29. A computer readable medium having computer readable code embodied therein for providing information to a customer, the computer readable code comprising:
a receiving module configured to receive a substance from the customer;
an analyzing module configured to analyze the substance;
a storing module configured to store results of the analysis of the substance in a database; and
an allowing module configured to allow the customer to access the results of the analysis of the substance stored in the database via a network.

30. A system for providing information to a customer, comprising:
means for receiving a substance from the customer;
means for analyzing the substance;
means for storing results of the analysis of the substance in a database; and
means for allowing the customer to access the results of the analysis of the substance stored in the database via a network.

31. A method for providing information to a customer via a network, comprising the steps of:
analyzing a substance received from the customer;
generating a report containing results of the analysis of the substance;
authenticating a user corresponding to the customer; and
allowing the user, when authenticated, to access the report via the network using a computer interface.

32. The method of claim 31, further comprising the step of:
storing the results of the analysis of the substance in a database.

33. The method of claim 31, wherein the customer interface includes a library of technical references.

34. The method of claim 31, wherein the customer interface includes membership information corresponding to the user.

35. The method of claim 31, wherein the customer interface includes a troubleshooting module.

36. The method of claim 31, wherein the customer interface includes a product ordering module.

37. The method of claim 31, wherein the customer interface includes an emulation module.

38. The method of claim 31, wherein the customer interface includes a file exchange module.

39. The method of claim 31, wherein the customer interface is customizable.

40. The method of claim 32, wherein the database stores information about the customer.

41. The method of claim 32, wherein the database stores information about an industry.

42. The method of claim 31, wherein the authenticating step further comprises the substep of:
providing access to an analysis service provider to a registered user.

43. The method of claim 31, wherein the authenticating step further comprises the substep of:
providing general public access to an analysis service provider.

44. The method of claim 31, wherein the analyzing step further comprises the substep of:
analyzing the substance using analysis tools.

45. The method of claim 31, wherein the analyzing step further comprises the substep of:
analyzing the substance using customer-specific analysis.

46. The method of claim 31, wherein the analyzing step further comprises the substep of:
analyzing the substance using industry analysis.

47. The method of claim 31, wherein the generating step further comprises the substep of:
generating the report using a report generator.

48. The method of claim 31, wherein the generating step further comprises the substep of:
generating user reports.

49. The method of claim 31, wherein the generating step further comprises the substep of:
providing an interface for viewing reports.

50. The method of claim 31, wherein the generating step further comprises the substep of:
generating the report using report formats.

51. The method of claim 31, wherein the substance is a used catalyst.

52. The method of claim 31, wherein the substance is a new catalyst.

53. An analysis service provider for providing information to a customer via a network, comprising:
an analysis module for analyzing a substance received from the customer;
a reporting module for generating a report containing results of the analysis of the substance;
a security module for authenticating a user corresponding to the customer; and
a customer interface for allowing the user, when authenticated, to access the report via the network.

54. The analysis service provider of claim 53, further comprising:
a database for storing the results of the analysis of the substance.

55. The analysis service provider of claim 53, wherein the customer interface includes a library of technical references.

56. The analysis service provider of claim 53, wherein the customer interface includes membership information corresponding to the user.

57. The analysis service provider of claim 53, wherein the customer interface includes a troubleshooting module.

58. The analysis service provider of claim 53, wherein the customer interface includes a product ordering module.

59. The analysis service provider of claim 53, wherein the customer interface includes an emulation module.

60. The analysis service provider of claim 53, wherein the customer interface includes a file exchange module.

61. The analysis service provider of claim 53, wherein the customer interface is customizable.

62. The analysis service provider of claim 54, wherein the database stores information about the customer.

63. The analysis service provider of claim 54, wherein the database stores information about an industry.

64. The analysis service provider of claim 53, wherein the security module includes a user authentication module for providing access to the analysis service provider to a registered user.

65. The analysis service provider of claim 53, wherein the security module includes a general public access module for providing general public access to the analysis service provider.

66. The analysis service provider of claim 53, wherein the analysis module includes analysis tools.

67. The analysis service provider of claim 53, wherein the analysis module includes customer-specific analysis.

68. The analysis service provider of claim 53, wherein the analysis module includes industry analysis.

69. The analysis service provider of claim 53, wherein the reporting module includes a report generator.

70. The analysis service provider of claim 53, wherein the reporting module includes user reports.

71. The analysis service provider of claim 53, wherein the reporting module includes an interface for viewing reports.

72. The analysis service provider of claim 53, wherein the reporting module includes report formats.

73. The analysis service provider of claim 53, wherein the substance is a used catalyst.

74. The analysis service provider of claim 53, wherein the substance is a new catalyst.

75. A computer readable medium having computer readable code embodied therein for providing information to a customer via a network, the computer readable code comprising:
an analysis module for analyzing a substance received from the customer;
a reporting module for generating a report containing results of the analysis of the substance;
a security module for authenticating a user corresponding to the customer; and
a customer interface for allowing the user, when authenticated, to access the report via the network.

76. A system for providing information to a customer via a network, comprising:
means for analyzing a substance received from the customer;
means for generating a report containing results of the analysis of the substance;
means for authenticating a user corresponding to the customer; and
means for allowing the user, when authenticated, to access the report via the network.

77. A method for allowing users to access data via a network, comprising the steps of:
registering first user information for a first user, the first user information including first user preferences;
registering second user information for a second user, the second user information including second user preferences and an access reference to the first user;
receiving a request from the second user to access data by emulating the first user;
authenticating the second user with the access reference; and
when the second user is authenticated, allowing the second user to access the data via the network using the first user preferences.

78. The method of claim 77, wherein the first user information further includes a level of access for the first user, and further comprising the step of:
when the second user is authenticated, allowing the second user to access the data according to the level of access for the first user.

79. The method of claim 77, wherein the data corresponds to a customer.

80. The method of claim 77, wherein the data includes results of analysis of a substance received from a customer.

81. The method of claim 77, wherein the data includes results of analysis of a new substance purchased by a customer.

82. The method of claim 77, wherein the data includes a customer-specific report containing results of analysis of a substance received from a customer.

83. The method of claim 77, wherein the data includes an industry comparison report containing results of analysis of a substance received from a customer compared with industry data.

84. The method of claim 77, wherein the second user is a supervisor of the first user.

85. The method of claim 77, wherein the second user is a trainer.

86. The method of claim 77, wherein the second user is a salesperson.

87. The method of claim 77, wherein the allowing step further comprises the substep of:
enabling the second user to download the data.

88. The method of claim 77, wherein the allowing step further comprises the substep of:
enabling the second user to view the data using a Web browser.

89. The method of claim 77, wherein the allowing step further comprises the substep of:
sending the data to the second user via e-mail.

90. The method of claim 80, wherein the substance is a used catalyst.

91. The method of claim 81, wherein the new substance is a new catalyst.

92. A system for allowing users to access data via a network, comprising:
a first registering component configured to register a first user in formation for a first user, the first user information including first user preferences;
a second registering component configured to register a second user information for a second user, the second user information including second user preferences and an access reference to the first user;
a receiving component configured to receive a request from the second user to access data by emulating the first user;
an authenticating component configured to authenticate the second user with the access reference; and
a first allowing component configured to allow the second user, when the second user is authenticated, to access the data via the network using the first user preferences.

93. The system of claim 92, wherein the first user information further includes a level of access for the first user, and further comprising:
a second allowing component configured to allow the second user, when the second user is authenticated, to access the data according to the level of access for the first user.

94. The system of claim 92, wherein the data corresponds to a customer.

95. The system of claim 92, wherein the data includes results of analysis of a substance received from a customer.

96. The system of claim 92, wherein the data includes results of analysis of a new substance purchased by a customer.

97. The system of claim 92, wherein the data includes a customer-specific report containing results of analysis of a substance received from a customer.

98. The system of claim 92, wherein the data includes an industry comparison report containing results of analysis of a substance received from the customer compared with industry data.

99. The system of claim 92, wherein the second user is a supervisor of the first user.

100. The system of claim 92, wherein the second user is a trainer.

101. The system of claim 92, wherein the second user is a salesperson.

102. The system of claim 92, wherein the first allowing component further comprises:
a first enabling component configured to enable the second user to download the data.

103. The system of claim 92, wherein the first allowing component further comprises:
a second enabling component configured to enable the second user to view the data using a Web browser.

104. The system of claim 92, wherein the first allowing component further comprises:
a sending component configured to send the data to the second user via e-mail.

105. The system of claim 95, wherein the substance is a used catalyst.

106. The system of claim 96, wherein the new substance is a new catalyst.

107. A computer readable medium having computer readable code embodied therein for allowing users to access data via a network, the computer readable code comprising:
a first registering module configured to register first user information for a first user, the first user information including first user preferences;
a second registering module configured to register second user information for a second user, the second user information including second user preferences and an access reference to the first user;
a receiving module configured to receive a request from the second user to access data by emulating the first user;
an authenticating module configured to authenticate the second user with the access reference; and
an allowing module configured to allow the second user, when the second user is authenticated, to access the data via the network using the first user preferences.

108. A system for allowing users to access data via a network, comprising:
means for registering first user information for a first user, the first user information including first user preferences;
means for registering second user information for a second user, the second user information including second user preferences and an access reference to the first user;
means for receiving a request from the second user to access data by emulating the first user;
means for authenticating the second user with the access reference; and
means for allowing the second user, when the second user is authenticated, to access the data via the network using the first user preferences.

109. A method for providing information to a customer, comprising the steps of:
storing a file format specification corresponding to the customer;
receiving a datafile from the customer via a network;
inputting data corresponding to the customer into the datafile, wherein the data corresponding to the customer includes results of analysis of a substance.
formatting the datafile according to the file format specification corresponding to the customer; and
allowing the customer to access the formatted datafile via the network.

110. The method of claim 109, further comprising the steps of:
receiving the substance from the customer; and
analyzing the substance.

111. The method of claim 109, further comprising the steps of:
receiving an order for a new substance from the customer; and
analyzing the new substance;
and wherein the data corresponding to the customer further includes results of the analysis of the new substance via the network.

112. The method of claim 109, wherein the allowing step further comprises the substep of:
enabling the customer to download the formatted datafile.

113. The method of claim 109, further comprising the step of:
manipulating the data corresponding to the customer using proprietary models and formulas;
and wherein the allowing step further comprises the substep of:
enabling the customer to view the formatted datafile without accessing the proprietary models and formulas.

114. The method of claim 109, wherein the allowing step further comprises the substep of:
enabling the customer to view the formatted datafile and save the formatted datafile for future use.

115. The method of claim 109, wherein the allowing step further comprises the substep of:
enabling the customer to view the formatted datafile using a Web browser.

116. The method of claim 109, wherein the allowing step further comprises the substep of:
sending the formatted datafile to the customer via e-mail.

117. The method of claim 109, wherein the datafile is an Excel spreadsheet format.

118. The method of claim 109, wherein the inputting step is performed manually.

119. The method of claim 109, wherein the inputting step is performed automatically.

120. The method of claim 109, wherein the inputting step is performed by the customer.

121. The method of claim 109, wherein the substance is a used catalyst.

122. The method of claim 111, wherein the new substance is a new catalyst.

123. A system for providing information to a customer, comprising:
a storing component configured to store a file format specification corresponding to the customer;
a first receiving component configured to receive a datafile from the customer via a network;
an inputting component configured to input data corresponding to the customer into the datafile, wherein the data corresponding to the customer includes results of analysis of a substance.
a formatting component configured to format the datafile according to the file format specification corresponding to the customer; and
an allowing component configured to allow the customer to access the formatted datafile via the network.

124. The system of claim 123, further comprising:
a second receiving component configured to receive the substance from the customer; and
a first analyzing component configured to analyze the substance.

125. The system of claim 123, further comprising:
a third receiving component configured to receive an order for a new substance from the customer; and
a second analyzing component configured to analyze the new substance;
and wherein the data corresponding to the customer further includes results of the analysis of the new substance via the network.

126. The system of claim 123, wherein the allowing component further comprises:
a first enabling component configured to enable the customer to download the formatted datafile.

127. The system of claim 123, further comprising:
a manipulating component configured to manipulate the data corresponding to the customer using proprietary models and formulas;
and wherein the allowing component further comprises:
a second enabling component configured to enable the customer to view the formatted datafile without accessing the proprietary models and formulas.

128. The system of claim 123, wherein the allowing component further comprises:
a third enabling component configured to enable the customer to view the formatted datafile and save the formatted datafile for future use.

129. The system of claim 123, wherein the allowing component further comprises:
a fourth enabling component configured to enable the customer to view the formatted datafile using a Web browser.

130. The system of claim 123, wherein the allowing component further comprises:
a sending component configured to send the formatted datafile to the customer via e-mail.

131. The system of claim 123, wherein the datafile is an Excel spreadsheet format.

132. The system of claim 123, wherein the inputting component operates manually.

133. The system of claim 123, wherein the inputting component operates automatically.

134. The system of claim 123, wherein the inputting component is operated by the customer.

135. The system of claim 123, wherein the substance is a used catalyst.

136. The system of claim 125, wherein the new substance is a new catalyst.

137. A computer readable medium having a computer readable code embodied therein for providing information to a customer, the computer readable code comprising:
a storing module configured to store a file format specification corresponding to the customer;
a receiving module configured to receive a datafile from the customer via a network;
an inputting module configured to input data corresponding to the customer into the datafile, wherein the data corresponding to the customer includes results of analysis of a substance.
a formatting module configured to format the datafile according to the file format specification corresponding to the customer; and
an allowing module configured to allow the customer to access the formatted datafile via the network.

138. A system for providing information to a customer, comprising:
means for storing a file format specification corresponding to the customer;
means for receiving a datafile from the customer via a network;
means for inputting data corresponding to the customer into the datafile, wherein the data corresponding to the customer includes results of analysis of a substance.
means for formatting the datafile according to the file format specification corresponding to the customer; and
means for allowing the customer to access the formatted datafile via the network.

139. A method for providing information to a customer, comprising the steps of:
receiving a substance from the customer;
analyzing the substance;
generating a report including results of the analysis of the substance;
storing the report in a database; and
allowing the customer to access the report stored in the database via a network.

140. The method of claim 139, wherein the allowing step further comprises the substep of:
enabling the customer to download the report.

141. The method of claim 139, wherein the allowing step further comprises the substep of:
enabling the customer to view the report using a Web browser.

142. The method of claim 139, wherein the allowing step further comprises the substep of:
sending the report to the customer via e-mail.

143. The method of claim 139, wherein the report is a customer-specific report including historical data about substances received from the customer.

144. The method of claim 139, wherein the report is an industry comparison report containing results of the analysis of the substance compared with industry data.

145. The method of claim 139, further comprising the steps of:
receiving an order for a new substance from the customer;
analyzing the new substance;
generating a fresh substance report including results of the analysis of the new substance; and
allowing the customer to access the fresh substance report via the network.

146. The method of claim 139, wherein the substance is a used catalyst.

147. The method of claim 139, wherein the substance is a new catalyst.

148. A system for providing information to a customer, comprising:
a first receiving component configured to receive a substance from the customer;
a first analyzing component configured to analyze the substance;
a first generating component configured to generate a report including results of the analysis of the substance;
a storing component configured to store the report in a database; and
a first allowing component configured to allow the customer to access the report stored in the database via a network.

149. The system of claim 148, wherein the first allowing component further comprises:
a first enabling component configured to enable the customer to download the report.

150. The system of claim 148, wherein the first allowing component further comprises:
a second enabling component configured to enable the customer to view the report using a Web browser.

151. The system of claim 148, wherein the first allowing component further comprises:
a sending component configured to send the report to the customer via e-mail.

152. The system of claim 148, wherein the report is a customer-specific report including historical data about substances received from the customer.

153. The system of claim 148, wherein the report is an industry comparison report containing results of the analysis of the substance compared with industry data.

154. The system of claim 148, further comprising:
a second receiving component configured to receive an order for a new substance from the customer;
a second analyzing component configured to analyze the new substance;
a second generating component configured to generate a fresh substance report including results of the analysis of the new substance; and
a second allowing component configured to allow the customer to access the fresh substance report via the network.

155. The system of claim 148, wherein the substance is a used catalyst.

156. The system of claim 148, wherein the substance is a new catalyst.

157. A computer readable medium having computer readable code embodied therein for providing information to a customer, the computer readable code comprising:
a receiving module configured to receive a substance from the customer;
an analyzing module configured to analyze the substance;
a generating module configured to generate a report including results of the analysis of the substance;
a storing module configured to store the report in a database; and
an allowing module configured to allow the customer to access the report stored in the database via a network.

158. A system for providing information to a customer, comprising:
means for receiving a substance from the customer;
means for analyzing the substance;
means for generating a report including results of the analysis of the substance;
means for storing the report in a database; and
means for allowing the customer to access the report stored in the database via a network.

159. A method for providing industry information to customers, comprising the steps of:
receiving substances from a plurality of customers that belong to an industry;
analyzing the substances to determine data about the industry;
building a database containing the data about the industry; and
allowing at least one of the customers to access the data about the industry via a network.

160. The method of claim 159, wherein the allowing step further comprises the substep of:
enabling the at least one customer to download the data about the industry.

161. The method of claim 159, wherein the allowing step further comprises the substep of:
enabling the at least one customer to view the data about the industry using a Web browser.

162. The method of claim 159, wherein the allowing step further comprises the substep of:
sending the data about the industry to the at least one customer via e-mail.

163. The method of claim 159, wherein the industry is the refining catalysts industry and the plurality of customers are oil refineries.

164. The method of claim 159, wherein the data about the industry conceals the identify of the plurality of customers.

165. The method of claim 159, further comprising the step of:
enabling the at least one customer to access information about a substance received from at least one customer compared with the data about the industry.

166. The method of claim 159, wherein the substances include at least one used catalyst.

167. The method of claim 159, wherein the substances include at least one new catalyst.

168. A system for providing industry information to customers, comprising:
a receiving component configured to receive substances from a plurality of customers that belong to an industry;
an analyzing component configured to analyze the substances to determine data about the industry;
a building component configured to build a database containing the data about the industry; and
an allowing component configured to allow at least one of the customers to access the data about the industry via a network.

169. The system of claim 168, wherein the allowing component further comprises:
a first enabling component configured to enable the at least one customer to download the data about the industry.

170. The system of claim 168, wherein the allowing component further comprises:
a second enabling component configured to enable the at least one customer to view the data about the industry using a Web browser.

171. The system of claim 168, wherein the allowing component further comprises:
a sending component configured to send the data about the industry to the at least one customer via e-mail.

172. The system of claim 168, wherein the industry is the refining catalysts industry and the plurality of customers are oil refineries.

173. The system of claim 168, wherein the data about the industry conceals the identify of the plurality of customers.

174. The system of claim 168, further comprising:
a third enabling component configured to enable at least one customer to access information about a substance received from the at least one customer compared with the data about the industry.

175. The system of claim 168, wherein the substances include at least one used catalyst.

176. The system of claim 168, wherein the substances include at least one new catalyst.

177. A computer readable medium having computer readable code embodied therein for providing industry information to customers, the computer readable code comprising:
a receiving module configured to receive substances from a plurality of customers that belong to an industry;
an analyzing module configured to analyze the substances to determine data about the industry;
a building module configured to build a database containing the data about the industry; and
an allowing module configured to allow at least one of the customers to access the data about the industry via a network.

178. A system for providing industry information to customers, comprising:
means for receiving substances from a plurality of customers that belong to an industry;
means for analyzing the substances to determine data about the industry;
means for building a database containing the data about the industry; and
means for allowing at least one of the customers to access the data about the industry via a network.

179. A method for securely providing information to a user via a network, comprising the steps of:
registering the user and a corresponding customer;
storing data about analysis of a substance corresponding to the customer;
receiving a request from the user to access the stored data via the network;
authenticating the user using a user name, a password, and a verification tool; and
when the user is authenticated, allowing the user to access the stored data about the customer via the network.

180. The method of claim 179, wherein the verification tool is at least one of an IP address of a computer corresponding to the user and a digital certificate.

181. The method of claim 179, wherein the stored data includes results of analysis of a substance received from the customer.

182. The method of claim 179, wherein the stored data includes results of analysis of a new substance purchased by the customer.

183. The method of claim 179, wherein the allowing step further comprises the substep of:
enabling the user to download the stored data.

184. The method of claim 179, wherein the allowing step further comprises the substep of:
enabling the user to view the stored data using a Web browser.

185. The method of claim 179, wherein the allowing step further comprises the substep of:
sending the stored data to the user via e-mail.

186. The method of claim 179, wherein the substance is a used catalyst.

187. The method of claim 179, wherein the substance is a new catalyst.

188. A system for securely providing information to a user via a network, comprising:
a registering component configured to register the user and a corresponding customer;
a storing component configured to store data about analysis of a substance corresponding to the customer;
a receiving component configured to receive a request from the user to access the stored data via the network;
an authenticating component configured to authenticate the user using a user name, a password, and a verification tool; and
an allowing component configured to allow the user, when the user is authenticated, to access the stored data about the customer via the network.

189. The system of claim 188, wherein the verification tool is at least one of an IP address of a computer corresponding to the user and a digital certificate.

190. The system of claim 188, wherein the stored data includes results of analysis of a substance received from the customer.

191. The system of claim 188, wherein the stored data includes results of analysis of a new substance purchased by the customer.

192. The system of claim 188, wherein the allowing component further comprises:
a first enabling component configured to enable the user to download the stored data.

193. The system of claim 188, wherein the allowing component further comprises:
a second enabling component configured to enable the user to view the stored data using a Web browser.

194. The system of claim 188, wherein the allowing component further comprises:
a sending component configured to send the stored data to the user via e-mail.

195. The system of claim 188, wherein the substance is a used catalyst.

196. The system of claim 188, wherein the substance is a new catalyst.

197. A computer readable medium having computer readable code embodies therein for securely providing information to a user via a network, the computer readable code comprising:
a registering module configured to register the user and a corresponding customer;
a storing module configured to store data about analysis of a substance corresponding to the customer;
a receiving module configured to receive a request from the user to access the stored data via the network;
an authenticating module configured to authenticate the user using a user name, a password, and a verification tool; and
an allowing module configured to allow the user, when the user is authenticated, to access the stored data about the customer via the network.

198. A system for securely providing information to a user via a network, comprising:
means for registering the user and a corresponding customer;
means for storing data about analysis of a substance corresponding to the customer;
means for receiving a request from the user to access the stored data via the network;
means for authenticating the user using a user name, a password, and a verification tool; and
means for allowing the user, when the user is authenticated, to access the stored data about the customer via the network.
